(19) United States
(12) Patent Application Publication
(10) Pub. No.: US 2009/0293135 A1
(43) Pub. Date: Nov. 26, 2009

(54) INFORMATION PROCESSING APPARATUS AND CONTROL METHOD THEREFOR

(75) Inventor: Yoshihito Nanaumi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/468,192

(22) Filed: May 19, 2009

(30) Foreign Application Priority Data
May 20, 2008 (JP) 2008-131975

(51) Int. Cl. G06F 7/04; G06F 21/00

(52) U.S. Cl. 726/28

(57) ABSTRACT

An information processing apparatus includes a document registration unit configured to register a document, a data extraction unit configured to extract a content of the document, a first setting unit configured to set an access right to the document to each user, and a first character string registration unit configured to register a character string for each user. In the information processing apparatus, when the document is registered by the document registration unit, the first setting unit sets an access right of a user to the document based on a result of comparison of the character string registered by the first character string registration unit with the content of the document extracted by the data extraction unit.

### BACKGROUND OF THE INVENTION

1. Field of the Invention

The present invention relates to an information processing apparatus such as a computer and a control method therefor.

2. Description of the Related Art

In recent years, along with increased awareness of information security, it is desired that a document management system is capable of preventing leakage of information by setting an appropriate access right to information input into the system, and properly restricting an access to confidential information to implement high data security.

Generally, in a document management system, an administrator determines a specific policy and sets an access right to access each folder and document to manage a document.

For example, Japanese Patent Application Laid-Open No. 2002-041548 discusses a method in which an access right set to a registration destination is set to a document in registering the document. More specifically, in this method, an access right is previously added to a document as additional information. The access right is set to the document according to the additional information.

In a method discussed by Japanese Patent Application Laid-Open No. 2001-222455, access right information is set to a registration destination of a document according to access right information on a registration source document. Further, in a method discussed by Japanese Patent Application Laid-Open No. 2003-304352, security information previously set to a scanning apparatus is set to a document to be registered when the scanning apparatus scans the document.

However, in a conventional document management system, it is difficult for a general user to recognize the content of access right that has been set to a registration destination. In other words, it is difficult for a general user to recognize who, among users, has a right to access the document to be registered.

An administrator of the system may desire to appropriately manage a document by managing an access right under a certain management policy. Meanwhile, a user who desires to register a document cannot recognize the content of the access right, namely the management policy set to the registration destination.

Accordingly, if an appropriate access right has not been set to a registration destination of a document to be stored therein, the document may be accessed by a third party who does not have an access right to the document after registration thereof. In such a case, leakage of confidential information may occur.

### SUMMARY OF THE INVENTION

An embodiment of the present invention is directed to an information processing apparatus capable of setting an access right to each user according to a content of a document and a control method therefor.

According to an aspect of the present invention, an information processing apparatus includes a document registration unit configured to register a document, a data extraction unit configured to extract a content of the document, a first setting unit configured to set an access right to the document to each user, and a first character string registration unit configured to register a character string for each user. In the information processing apparatus, when the document is registered by the document registration unit, the first setting unit sets an access right of a user to the document based on a result of comparison of the character string registered by the first character string registration unit and the content of the document extracted by the data extraction unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary configuration of an image forming system according to a first exemplary embodiment of the present invention.

FIG. 2 illustrates an exemplary configuration of an image forming apparatus illustrated in FIG. 1.

FIG. 3 illustrates an exemplary configuration of a data management unit illustrated in FIG. 2.

FIG. 4 illustrates an exemplary configuration of an image processing unit illustrated in FIG. 2.

FIG. 5 illustrates an example of a structure of tables stored in the document management unit illustrated in FIG. 2.

FIG. 6 illustrates an example of an access right setting according to the first exemplary embodiment of the present invention.

FIG. 7 illustrates an exemplary configuration of a document management unit according to the first exemplary embodiment of the present invention.

FIGS. 8A through 8F each illustrates an example of a table including table data stored in the document management unit illustrated in FIG. 7.

FIGS. 9A through 9E each illustrates an example of a table including table data stored in the document management unit illustrated in FIG. 7.

FIGS. 10A and 10B each illustrates an example of a display screen for registering an NG word according to the first exemplary embodiment of the present invention.

FIGS. 11A and 11B each illustrates an example of a display screen for registering an NG word according to the first exemplary embodiment of the present invention.

FIG. 12 is a flow chart illustrating an example of processing for registering an NG word according to the first exemplary embodiment of the present invention.

FIG. 13 illustrates an example of NG word registration processing according to the first exemplary embodiment of the present invention.

FIG. 14 illustrates an example of NG word registration processing according to the first exemplary embodiment of the present invention.

FIG. 15 is a flow chart illustrating an example of processing for registering a document according to the first exemplary embodiment of the present invention.

FIG. 16 illustrates an example of a user authentication information input screen according to the first exemplary embodiment of the present invention.

FIG. 17 illustrates an example of a screen displayed by an application for registering a document according to the first exemplary embodiment of the present invention.

FIG. 18 is a flow chart illustrating a detail of processing for setting an access right to a document in step in FIG. 15.

FIG. 19 illustrates an example of area division processing, optical character recognition (OCR) processing, and characteristic amount extraction processing according to the first exemplary embodiment of the present invention.

FIG. 20 is a flow chart illustrating a detail of processing in step S716 in FIG. 15.

FIG. 21 illustrates an example of a structure of tables stored in a document management unit according to a second exemplary embodiment of the present invention.

FIGS. 22A through 22C each illustrates an example of a display screen for registering an NG image according to the second exemplary embodiment of the present invention.

FIG. 23 is a flow chart illustrating an example of processing for registering an NG image according to the second exemplary embodiment of the present invention.

FIG. 24 is a flow chart illustrating a detail of processing for setting an access right to a document in step in FIG. 15.

FIG. 25 is a flow chart illustrating a detail of processing for setting an access right to a document in step in FIG. 15.

### DETAILED DESCRIPTION OF THE EMBODIMENTS

Various exemplary embodiments, features, and aspects of the present invention will be described in detail below with reference to the drawings. It is to be noted that the relative arrangement of the components, the numerical expressions, and numerical values set forth in these embodiments are not intended to limit the scope of the present invention.

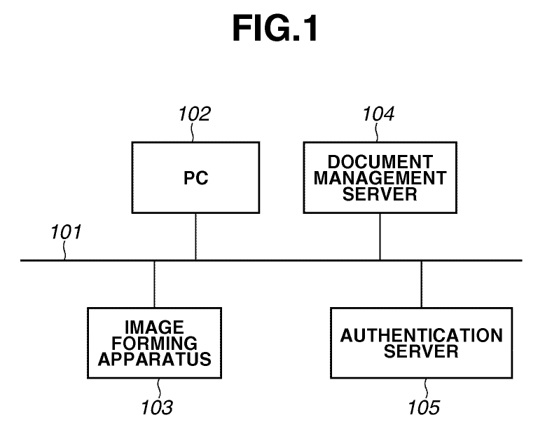

FIG. 1 illustrates an exemplary configuration of an image forming system according to a first exemplary embodiment. Referring to FIG. 1, the image forming system includes a personal computer (PC) 102, an image forming apparatus 103, a document management server 104, and an authentication server 105 which are in communication with one another via a local area network (LAN) 101. The LAN 101 is connected to a wide area network (WAN) or the Internet.

The PC 102 loads a system resource such as a printer driver from a hard disk (not illustrated) on a random access memory (RAM) (not illustrated). If a user requests printing by using an application, the PC 102 displays a print control screen by utilizing the printer driver to execute printing requested by the user. The image forming apparatus 103 is an image forming apparatus such as a multifunction peripheral (MFP).

The document the management server 104 provides a service for managing document data. The document management server 104 stores document data received from the PC 102 and the image forming apparatus 103.

The authentication server 105 manages user information and executes user authentication processing when a user authentication is requested by entering the user name and a password on the image forming apparatus 103, the PC 102, or the document management server 104. The authentication server 105 implements a function for uniquely identifying a user among the apparatuses connected to the LAN 101. ACTIVE DIRECTORY and Lightweight Directory Access Protocol (LDAP), for example, can be used as the authentication server 105.

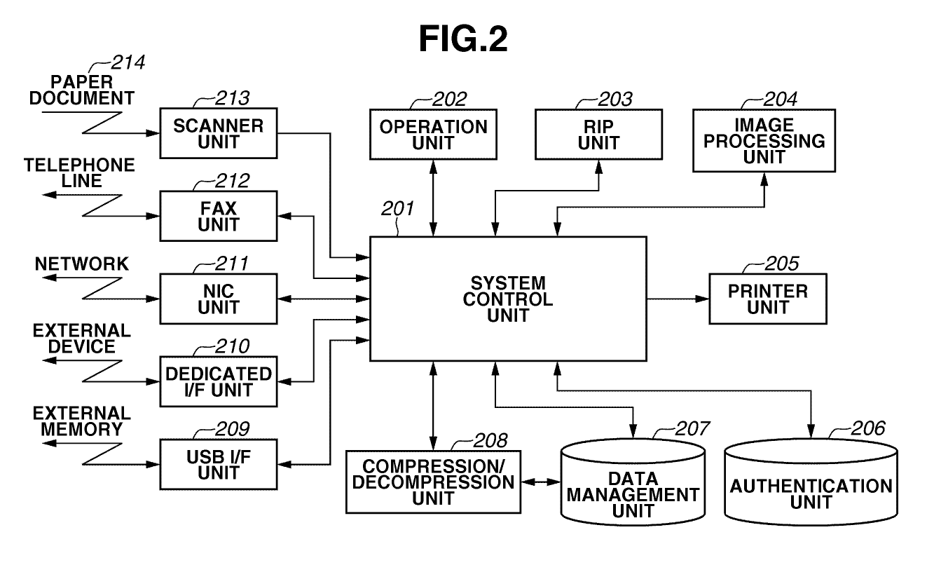

An exemplary configuration of the image forming apparatus 103 (FIG. 1) will be described in detail below with reference to FIG. 2. FIG. 2 illustrates an exemplary configuration of the image forming apparatus 103 (FIG. 1).

Referring to FIG. 2, the image forming apparatus 103 includes a built-in memory device such as a hard disk capable of storing a plurality of pieces of job data. The image forming apparatus 103 has a copy function for printing raster image data which is input by a scanner unit 213 and temporarily stored on the memory by using a printer unit 205. Furthermore, the image forming apparatus 103 has a print function for printing job data which is output by an external apparatus such as the PC 102 and temporarily stored on the memory by using the printer unit 205. The image forming apparatus 103 includes a plurality of functions in addition to the copy function and the print function.

As illustrated in FIG. 2, the image forming apparatus 103 includes the scanner unit 213. The scanner unit 213 scans an image of a paper document 214, executes processing on the scanned image, and generates raster image data based on the scanned image. Furthermore, the image forming apparatus 103 includes a FAX unit 212 such as a facsimile apparatus which transmits and receives an image via a telephone line.

Furthermore, the image forming apparatus 103 includes a network interface card (NIC) unit 211 for executing data communication via a network and a dedicated interface unit 210 for exchanging data with the external apparatus. In addition, the image forming apparatus 103 includes a universal serial bus interface (USB I/F) unit 209 which transmits and reads data to and from a USB device such as a USB memory. A system control unit 201 executes control for temporarily storing data according to the purpose of use of the data and determining a path for the data.

A data management unit 207 includes a memory such as a hard disk capable of storing various data. The data management unit 207 stores data from the scanner unit 213 under control by a control unit (a central processing unit (CPU) of the system control unit 201, for example) of the image forming apparatus 103.

In addition, the data management unit 207 stores data of a facsimile job input via the FAX unit 212 on the hard disk. Furthermore, the data management unit 207 stores various data such as data from the external apparatus (computer) input via the NIC unit 211 or data input via the dedicated interface unit 210 and the USB I/F unit 209 on the hard disk.

The system control unit 201 reads the data from the hard disk of the data management unit 207 and executes processing on the data when necessary. Further, the system control unit 201 transmits the processed data to the printer unit 205 to output and print the data. In addition, the system control unit 201 transmits various data read from the hard disk of the data management unit 207 to the external apparatus such as the PC 102, the document management server 104, or other image forming apparatus according to a user instruction.

Furthermore, the system control unit 201 compresses and decompresses various data if necessary to store and to read the data on the data management unit 207 by using a compression/decompression unit 208.

Generally, data is compressed by a conventional method such as Joint Photographic Experts Group (JPEG), Joint Bi-level Image Experts Group (JBIG), or ZIP compression method in transmitting data via the network. When data is input to the image forming apparatus 103, the compression/decompression unit 208 decompresses the compressed data.

An image processing unit 204 executes image processing on the raster image data from the scanner unit 213 and converts a data format of the data to output and print the data with the printer unit 205.

When page description language (PDL) data is input into the image forming apparatus 103, the system control unit 201 controls a raster image processor (RIP) unit 203 to execute RIP processing on the input PDL data. Then, the system control unit 201 executes image processing for printing image data with the image processing unit 204 when necessary.

The system control unit 201 can store intermediate data of the image data generated during the image processing on the data management unit 207 as necessary again. Then, the image data is transmitted to the printer unit 205 which forms an image. The printer unit 205 outputs the received image data.

An authentication unit 206 executes user authentication processing. When a user is successfully authenticated by the authentication unit 206, the authenticated user can utilize a function of the image forming apparatus 103.

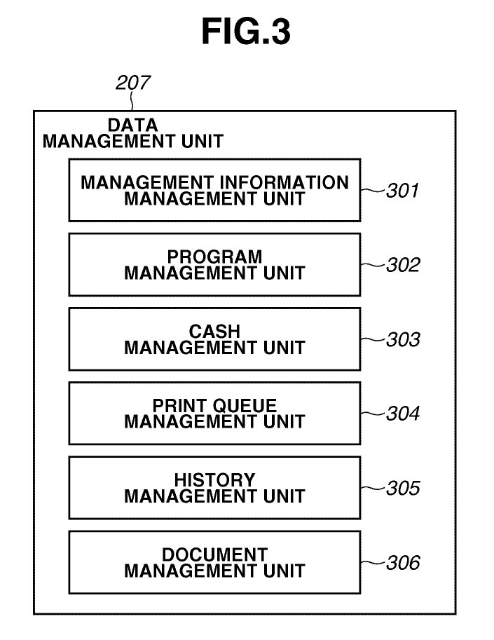

The data management unit 207 will be described in detail below with reference to FIG. 3. FIG. 3 illustrates an exemplary configuration of the data management unit 207 illustrated in FIG. 2.

Referring to FIG. 3, the data management unit 207 includes a management information management unit 301, a program management unit 302, a cash management unit 303, a print queue management unit 304, a history management unit 305, and a document management unit 306.

The management information management unit 301 stores management information for the data management unit 207. The program management unit 302 manages a program for controlling the image forming apparatus 103. The cash management unit 303 manages a cash area utilized by the system control unit 201 as a temporary data storage area during processing. The print queue management unit 304 manages a spool area for spooling data before printing.

The history management unit 305 manages a history of various processing executed by the image forming apparatus 103, such as a user operation history or a print history. The document management unit 306 manages various document data.

When data is stored on the data management unit 207, the data is encrypted. When the encrypted data is read from the data management unit 207, it is necessary to decrypt the data. Accordingly, the present exemplary embodiment can prevent leakage of information if a third party other than an authenticated user removes a hard disk drive (HDD) or a memory such as a RAM of the image forming apparatus 103 and attempts to read the content thereof.

The document management unit 306 manages document data in a folder layer. Here, “document data” refers to data including real data and a document attribute. “Real data” refers to raster image data and is stored as binary data.

The document attribute includes a document name, information about a person who has generated the document, and a document format. In addition, the document attribute includes text data extracted by executing OCR processing on raster image data and characteristic amount data of an image extracted from the raster image data.

The document management unit 306 can implement a full text search and a similar image search on document data by managing the text data extracted by OCR processing and characteristic amount data of an image associated with the document data.

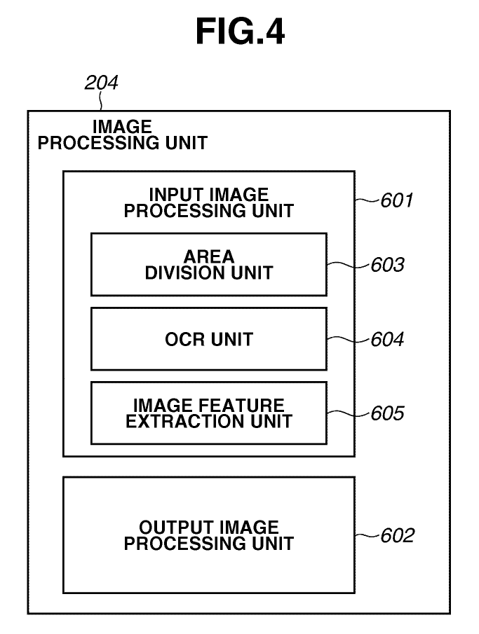

The image processing unit 204 will be described in detail below with reference to FIG. 4. FIG. 4 illustrates an exemplary configuration of the image processing unit 204 illustrated in FIG. 2.

Referring to FIG. 4, the image processing unit 204 is constituted by an input image processing unit 601 and an output image processing unit 602. The input image processing unit 601 executes image processing on raster image data output by the scanner unit 213. The output image processing unit 602 generates an image to be output by the printer unit 205 based on the raster image data. The input image processing unit 601 includes an area division unit 603, an OCR unit 604, and an image characteristic extraction unit 605.

The area division unit 603 analyzes the raster image data and divides the data into an area in which a text is drawn (character area) and an area in which an image is drawn (image area). The OCR unit 604 is a module that executes character recognition on the character area divided by the area division unit 603 and data extraction processing. The OCR unit 604 outputs text data (data coded by Unicode, for example) as a result of the character recognition.

The image characteristic extraction unit 605 is a module that extracts a characteristic to be used as a criterion of determining similarity between images from the image area divided by the area division unit 603. In this regard, various conventional methods for extracting a characteristic can be used for effectively executing similar image search. The present exemplary embodiment is not limited to a specific algorithm and uses a plurality of effective methods for effectively executing the similar image search.

The present exemplary embodiment can employ the following methods, for example.

(1) A method in which an object is extracted based on an edge in an image and a shape of the object is determined In this method, a degree of similarity between images is determined based on the shape, a layout, and a color of the object and a positional relationship among a plurality of objects.
(2) A method that uses a combination of colors dominantly used in the entire image and a color pattern thereof which are extracted as a histogram to determine the degree of similarity between images
(3) A method that uses various arithmetic operations (Fourier-Mellin Transform, for example) for extracting the characteristic amount which can be determined by cognitive similarity determination

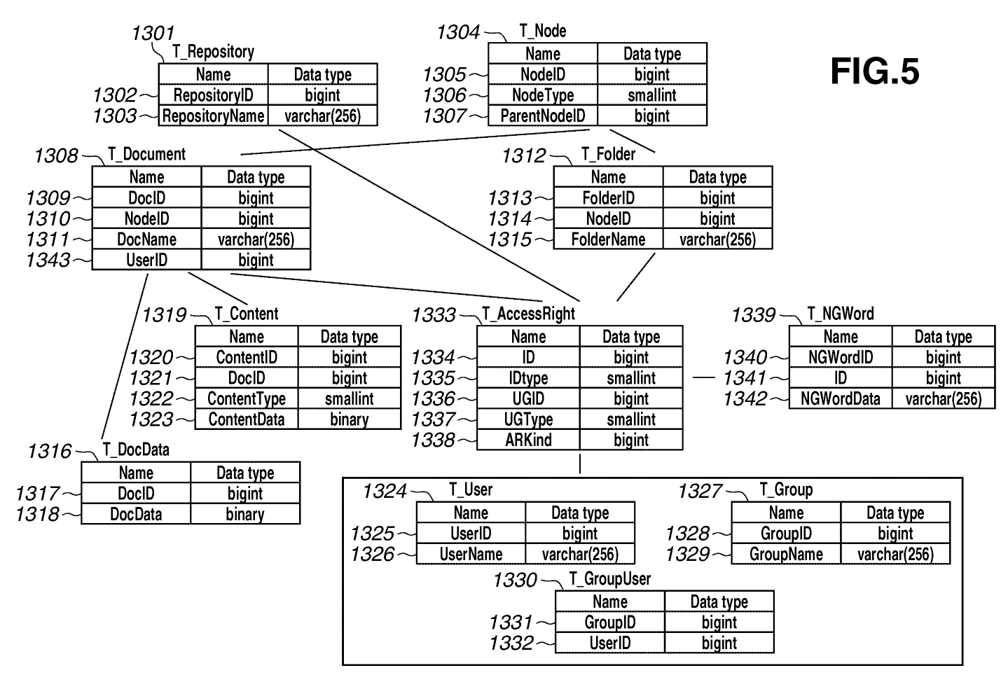

The above-described document management unit will be described in detail below with reference to FIG. 5. FIG. 5 illustrates an example of the structure of tables stored in the document management unit 306 illustrated in FIG. 3.

Referring to FIG. 5, the document management unit 306 manages document data in a folder layer. All pieces of document data and all folders belong to a specific repository. The repository corresponds to a parent node in a layer structure of all pieces of document data and folders. Further, the repository corresponds to an HDD and a memory of the image forming apparatus, a removable USB storage device, an HDD of another image forming apparatus, or the document management server 104. The repository becomes operable by mounting the same on the image forming apparatus 103.

Since the repository can absorb differences among different apparatuses and systems, the present exemplary embodiment can allow a user to execute processing on a document by a uniform operation regardless of which apparatus or system the user operates.

Anode is an abstraction of a folder and document data. The node manages the layer structure. A plurality of nodes can be included in one repository. A plurality of nodes can be included in one node.

A T_Repository table 1301 manages data in the repository. The T_Repository table 1301 includes a repository identification (ID) item 1302 and a repository name item 1303. The repository ID item 1302 stores numeric data for uniquely identifying the repository. The repository name item 1303 stores repository name data (char type array data).

The T_Node table 1304 manages data of the node. The T_Node table 1304 includes a node ID item 1305, a node type item 1306, and a parent node ID item 1307. The node ID item 1305 stores numeric data for uniquely identifying the node. The node type item 1306 stores numeric data “1” or “2” to indicate which of a folder and document data the node is. More specifically, if the node is the folder, the node type item 1306 stores the value “1”. On the other hand, if the node is document data, the node type item 1306 stores the value “2”.

The parent node ID item 1307 stores numeric data of an ID of a parent node to manage a layer relationship between nodes. The parent node ID item 1307 stores a repository ID of the repository or a node ID of the node.

A T_Document table 1308 manages document data. The T_Document table 1308 includes a Doc ID item 1309, a node ID item 1310, a Doc Name item 1311, and a user ID item 1343. The Doc ID item 1309 stores numeric data for uniquely identifying document data. The node ID item 1310 stores numeric data. The value of the node ID item 1310 is always stored in the node ID item 1305 of the T_Node table 1304.

The node ID item 1310 is used to associate the node with the document data. The Doc Name item 1311 stores the name data (char type array data) of document data. The user ID item 1343 stores the user who has registered the document data.

A T_Folder table 1312 manages data of a folder. The T_Folder table 1312 includes a folder ID item 1313, a node ID item 1314, and a folder name item 1315. The folder ID item 1313 stores numeric data for uniquely identifying the folder. The node ID item 1314 stores numeric data. The value of the node ID item 1314 is always stored in the node ID item 1305 of the T_Node table 1304. The node ID item 1314 is used for associating the node with the folder. The folder name item 1315 stores name data (char type array data) of the folder.

A T_Doc data table 1316 manages real data of the document data. The real data includes not only the raster image data generated by the scanner unit 213 but also various data added to entity image data such as preview image data or thumbnail image data.

The T_Doc data table 1316 includes a Doc ID item 1317 and a Doc Data item 1318. The Doc ID item 1317 stores numeric data. The value of the Doc ID item 1317 is always stored in the Doc ID item 1309 of the T_Document table 1308. The Doc ID item 1317 is used for associating the document with the data. The Doc Data item 1318 stores the data as binary data.

A T_Content table 1319 manages text data and characteristic amount data. The text data is extracted from the raster image data (the real data of the document data) by the OCR unit 604. The characteristic amount data is extracted from the raster image data (the real data of the document data) by the image characteristic extraction unit 605. Hereinbelow, the text data and characteristic amount data may be collectively referred to as a “content” where necessary.

The T_Content table 1319 includes a content ID item 1320, a Doc ID item 1321, a content type item 1322, and a content data item 1323. The content ID item 1320 stores numeric data for uniquely identifying the content. The Doc ID item 1321 stores numeric data. The value of the Doc ID item 1321 is always stored in the Doc ID item 1309 of the T_Document table 1308. The Doc ID item 1321 is used for associating the document data with the content.

The content type item 1322 stores numeric data “1” or “2” to indicate which of text data processed by the OCR unit 604 and characteristic amount data processed by the image characteristic extraction unit 605 the content is. More specifically, if the content is the text data, the content type item 1322 stores the value “1”. On the other hand, if the content is the characteristic amount data, the content type item 1322 stores the value “2”. The content data item 1323 stores the text data and the characteristic amount data as binary data.

A T_User table 1324 manages user data. The T_User table 1324 includes a user ID item 1325 and a user name item 1326. The user ID item 1325 stores numeric data for uniquely identifying a user. The user ID item 1325 corresponds to a user ID generated by the authentication unit 206. The user name item 1326 stores name data (char type array data) of the user.

A T_Group table 1327 manages data of a group. A plurality of users can be included in one group. The T_Group table 1327 includes a group ID item 1328 and a group name item 1329. The group ID item 1328 stores numeric data for uniquely identifying the group. The group name item 1329 stores name data (char type array data) of the group.

A T_GroupUser table 1330 manages data that indicates a relationship between a group and a user. The T_GroupUser table 1330 includes a group ID item 1331 and a user ID item 1332.

A T_AccessRight table 1333 manages information about an access right to a repository, a folder, and a document. The T_AccessRight table 1333 includes an access right (AR) ID item, an ID item 1334, an ID type item 1335, a user/group (UG) ID item 1336, a UG type item 1337, and an AR kind item 1338. The AR ID item stores numeric data for uniquely identifying access right information. The ID item 1334 stores numeric data. The ID type item 1335 stores numeric data “1”, “2”, or “3” to indicate to which of the repository, the folder, or the document the ID is set. The repository, the folder, and the document can be uniquely identified by a combination of the ID item 1334 and the ID type item 1335.

The UG ID item 1336 stores numeric data. The UG type item 1337 stores numeric data “1”, “2”, or “3” to indicate the user, the group, or other person or group. The user, the group, and the other person or group can be uniquely identified by a combination of the UG ID item 1336 and the UG type item 1337.

The AR kind item 1338 stores numeric data which indicates an access right. A numerical value “0” of the access right indicates that both reading and writing/modification of data are inhibited. A numerical value “1” of the access right indicates that reading of data is permitted. A numerical value “5” of the access right indicates that both reading and writing/modification of data are permitted.

A T_NGWord table 1339 manages data of an NG word. The T_NGWord table 1339 includes an NG Word ID item 1340, an ID item 1341, and an NG Word data item 1342. The NG Word ID item 1340 stores numeric data for uniquely identifying the NG word. The ID item 1341 stores numeric data. A value of the ID item 1341 is included in the ID item 1334 of the T_AccessRight table 1333. The value of the ID item 1341 associates an NG word with the access right information. The NG Word data item 1342 stores NG Word data (char type array data).

In the present exemplary embodiment, raster image data and a document attribute are managed independently from each other. However, the present exemplary embodiment is not limited to the above configuration. That is, a document attribute can be managed in a document as metadata.

The access right information can be managed by the following method. That is, whether to permit or inhibit (indicated with a parameter value “-”) an operation of reading (indicated with a parameter value “r”) and writing/modifying (indicated with a parameter value “w”) of an access right can be set. As a user type, three user types such as a user, a group, and “Other” (a user other than a set user or group) are used to manage the access right information. In the present exemplary embodiment, a first setting unit sets an access right to a document to each user.

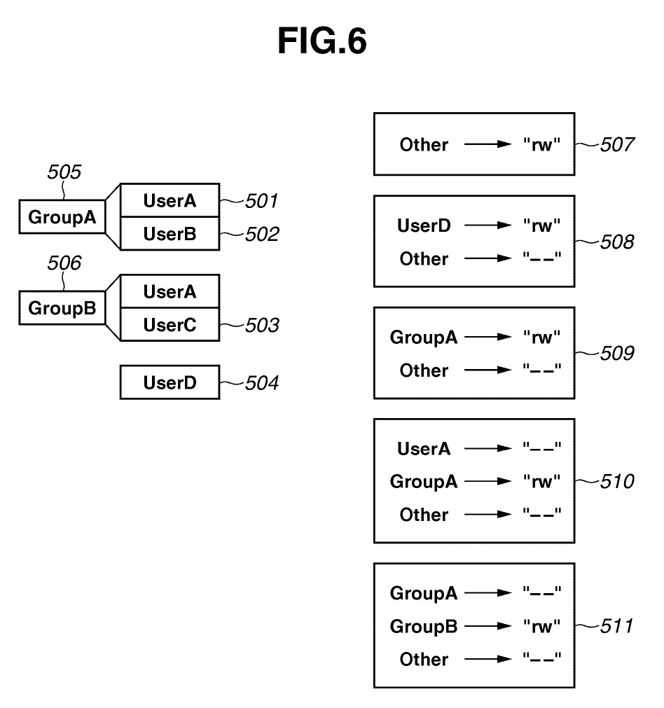

FIG. 6 illustrates an example of setting of an access right. Referring to FIG. 6, users such as a user A 501, a user B 502, a user C 503, and a user D 504, and groups such as a group A 505 and a group B 506 are set.

The group A 505 includes the user A 501 and the user B 502. The group B 506 includes the user A 501 and the user C 503. The user D 504 is not included in any group. A setting 507 indicates that parameter values “r” and “w” are set to “Other”. More specifically, the setting 507 indicates that all users are permitted to execute an operation of reading and writing/modification of data.

A setting 508 indicates that the parameter values “r” and “w” are set to the user D 504 and the parameter value “-” is set for both reading and writing/modification to “Other”. More specifically, the setting 508 indicates that only the user D 504 is permitted to execute the reading and writing/modification operations on the data while the other users are not.

A setting 509 indicates that the parameter values “r” and “w” are set to the group A 505 and the parameter value “−” is set for both reading and writing/modification to “Other”. More specifically, the setting 509 indicates that only the user A 501 and the user B 502 are permitted to execute the reading and writing/modification operations on the data while the other users are not.

A setting 510 indicates that the parameter value “-” is set for both reading and writing/modification to the user A 501, the parameter values “r” and “w” are set to the group A 505, and the parameter value “-” is set for both reading and writing/modification to “Other”. More specifically, the setting 510 indicates that only the user B 502 is permitted to execute the reading and writing/modification operations on the data while the user A 501 and the other users are not. If the contents of the access rights match one another among the user, the group, and “Other”, the access rights are prioritized in order of the user, the group, and “Other”.

A setting 511 indicates that the parameter value “-” is set for both reading and writing/modification to the group A 505, the parameter values “r” and “w” are set to the group B 506, and the parameter value “-” is set for both reading and writing/modification to “Other”. More specifically, the setting 511 indicates that only the user C 503 is permitted to execute the reading and writing/modification operations on the data while the user A 501, the user B 502, and the other users are not. If one user belongs to different groups at the same time and if the access rights of the groups of the user differ, the setting for inhibiting execution of operation on the data is applied by priority.

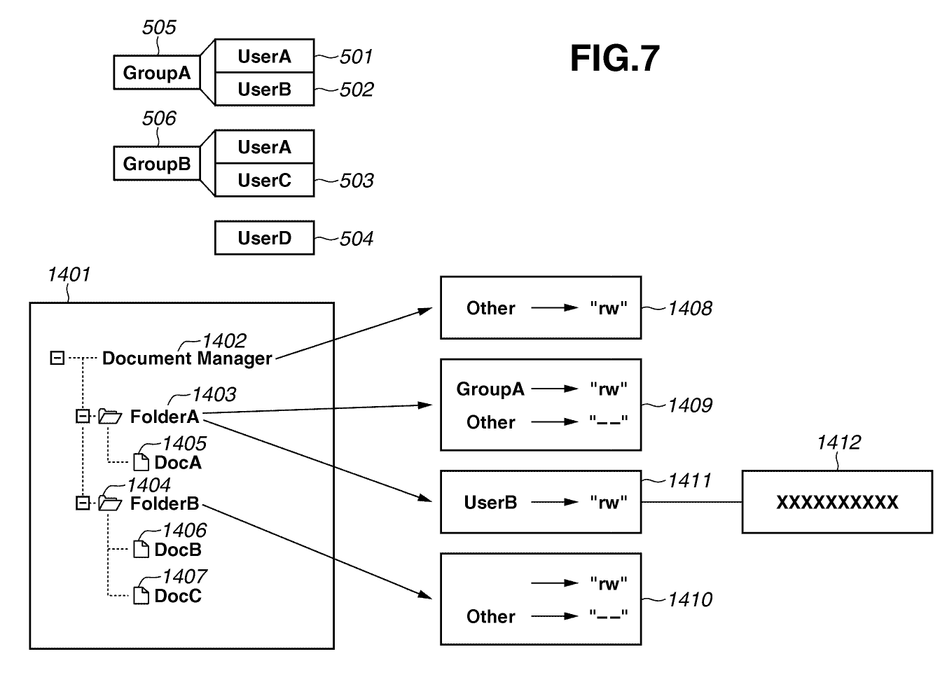

FIG. 7 illustrates an exemplary configuration of the document management unit 307 according to the present exemplary embodiment. Referring to FIG. 7, a document management area 1401 indicates a tree structure of the document management unit 306. The document management area 1401 indicates a relationship among a repository, a folder, and a document. In the example illustrated in FIG. 7, the user A 501, the user B 502, the user C 503, the user D 504, the group A 505, and the group B 506 are registered in the document management area 1401.

A Document Manager 1402 corresponds to a repository. A folder A 1403 and a folder B 1404 each correspond to a folder. A Doc A 1405, a Doc B 1406, and a Doc C 1407 each correspond to a document. Access right information 1408 includes information about an access right to the Document Manager 1402. The access right to a repository is applied to all folders and documents included in the repository.

Access right information 1409 includes information about an access right to the folder A 1403. Access right information 1410 includes information about an access right to the folder B 1404. The access right to a folder is applied to all folders and documents included in the folder. Access right information 1411 includes information about an access right to the folder A 1403. In addition, the access right information 1411 is associated with an NG word “XXXXXXXXX” 1412. In the example illustrated in FIG. 7, the access right information 1411 indicates that a setting for inhibiting the user B 502 from reading and writing/modifying a document including the NG word “XXXXXXXXX” 1412 included in the folder A 1403 has been set.

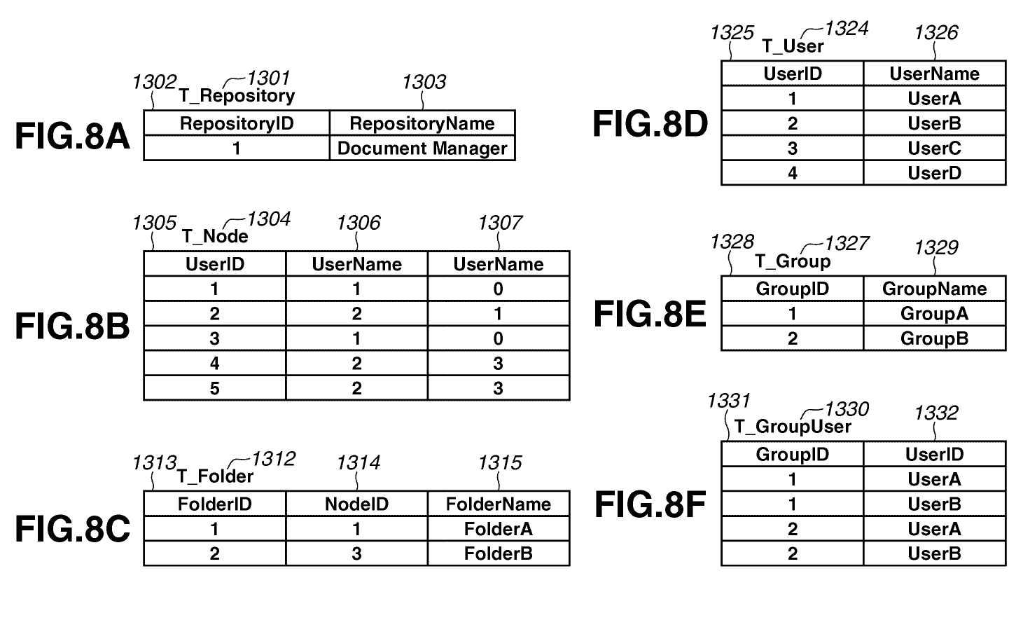

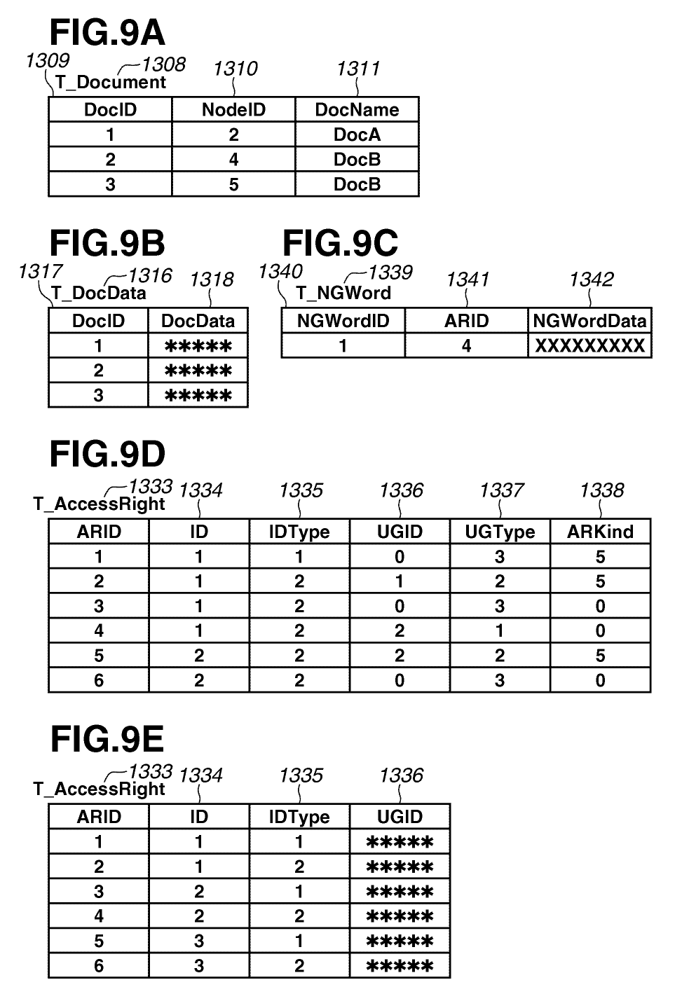

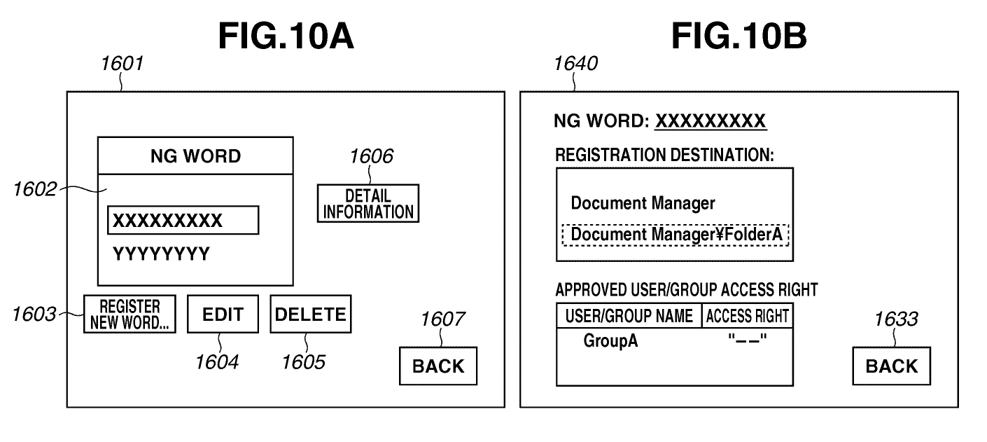

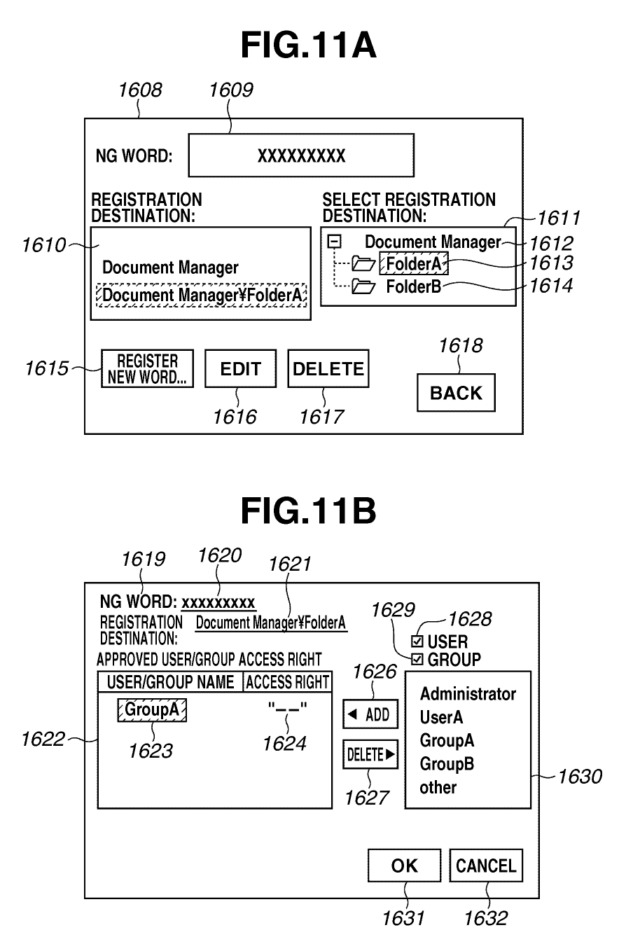

FIGS. 8A through 8F and FIGS. 9A through 9D each illustrates exemplary table data of the document management unit 306 (FIG. 7). FIGS. 10A and 10B and FIGS. 11A and 11B each illustrates an exemplary display screen for registering an NG word.

Referring to FIG. 10A, the user can register an NG word via an NG word registration initial screen 1601. A registered NG word display area 1602 displays a registered NG word. The user can select from among NG words displayed in the registered NG word display area 1602. A new NG word registration button 1603 can be operated by the user to register a new NG word. When the user presses the new NG word registration button 1603, the screen shifts to a document registration destination registration screen 1608 (FIG. 11A).

An NG word editing button 1604 can be operated by the user to change the setting for a registered NG word. When the user selects a registered NG word in the registered NG word display area 1602 and presses the NG word editing button 1604, the screen shifts to the document registration destination registration screen 1608.

A registered NG word deleting button 1605 can be operated by the user to delete a registered NG word. The user can delete a registered NG word by selecting an NG word via the registered NG word display area 1602 and pressing the registered NG word deleting button 1605. A details button 1606 can be operated by the user to display detailed information about the setting of a registered NG word. When the user selects an NG word via the registered NG word display area 1602 and presses the details button 1606, the screen shifts to an NG word detailed information display screen 1640 (FIG. 10B). A back button 1607 can be operated by the user to return to a screen displayed previous to the NG word registration initial screen 1601.

An administrator authority is necessary to newly register, edit, or delete an NG word. Accordingly, a button for shifting to the NG word registration initial screen 1601 is not displayed unless the user has the administrator authority. Although not illustrated in FIGS. 10A and 10B, the administrator authority can be set to a registered user. If the administrator authority is set to the user, the user is provided with an authority to execute all operations.

The document registration destination registration screen 1608 (FIG. 11A) is a screen for setting an NG word and an NG word registration destination. An NG word to be registered is entered in an NG word entering text box 1609. When the user selects the NG word entering text box 1609, a software keyboard screen is displayed to allow the user to enter an NG word thereby.

An NG word registration destination display area 1610 displays an already set registration destination corresponding to a registered NG word. An NG word registration destination selection area 1611 is a display area that allows the user to select an NG word registration destination.

A document management tree displayed in the NG word registration destination selection area 1611 is an example of the management executed by the document management unit 306 described above with reference to FIG. 7. More specifically, a Document Manager 1612 corresponds to the Document Manager 1402, a folder A 1613 corresponds to the folder A 1403, and a folder B 1614 corresponds to the folder B 1404.

A new NG word registration destination registration button 1615 can be selected after the user has selected the NG word registration destination selection area 1611. When the user presses the new NG word registration destination registration button 1615, the screen shifts to an access right setting screen 1619 (FIG. 11B).

An NG word registration destination editing button 1616 can be operated by the user to change the registration destination of an NG word. When the user selects a registration destination that has been registered via the NG word registration destination display area 1610, the NG word registration destination editing button 1616 becomes selectable. When the user presses the NG word registration destination editing button 1616, the screen shifts to the access right setting screen 1619.

A registration destination deleting button 1617 can be operated by the user to delete a registered registration destination. The user can delete a registered registration destination by selecting a registration destination via the registration destination display area 1610 and pressing the registration destination deleting button 1617. When the user presses a back button 1618, the display returns to the NG word registration initial screen 1601 (FIG. 10A).

The access right setting screen 1619 (FIG. 11B) is a screen for setting access right information of a user or a group to a designated NG word and registration destination. An NG word display area 1620 displays an NG word to be registered. An NG word registration destination display area 1621 displays a registration destination to which an NG word is to be registered.

A user/group access right information display area 1622 displays set access right information. A user/group display area 1630 displays a user and a group that has an access right to the registration destination. When a user check box 1628 is marked, a user is displayed. When a group check box 1629 is marked, a group is displayed.

An add button 1626 can be operated to add a user or a group. After selecting a user or a group via the user/group display area 1630, the add button 1626 becomes operable. Then, the user or group selected is added to the user/group access right information display area 1622 by pressing the add button 1626. A delete button 1627 can be operated to delete the set access right of a user or group. The delete button 1627 can be operated after selecting the access right to be deleted from among those displayed in the user/group access right information display area 1622. The access right of the user or the group is deleted from the user/group access right information display area 1622 when the user presses the delete button 1627 after selecting the same.

A user/group name 1623 indicates that the access right of the group A is registered. Access right information 1624 indicates that the group A has been inhibited from reading and writing/modifying the data. An OK button 1631 can be operated to apply the set access right information to the system. When the user presses the OK button 1631, the setting is applied to the system. Further, when the user presses the OK button 1631, the screen shifts to the document registration destination registration screen 1608. On the other hand, when the user presses a cancel button 1632, the screen shifts to the document registration destination registration screen 1608 without applying the setting.

The NG word detailed information display screen 1640 displays detailed information about a registered NG word. When the user presses the back button 1633, the screen shifts to the NG word registration initial screen 1601. In the example illustrated in FIG. 10B, the NG word detailed information display screen 1640 indicates that an NG word “XXXXXXXXX” has been registered. Further, the NG word detailed information display screen 1640 indicates that registration destinations “Document Manager” and “Document manager Yfolder A”, which are associated with the NG word, have been registered. In addition, the NG word detailed information display screen 1640 indicates that the group A is provided with the reading right and the writing/modifying right as the access right associated with the registration destination “Document Manager Yfolder A”.

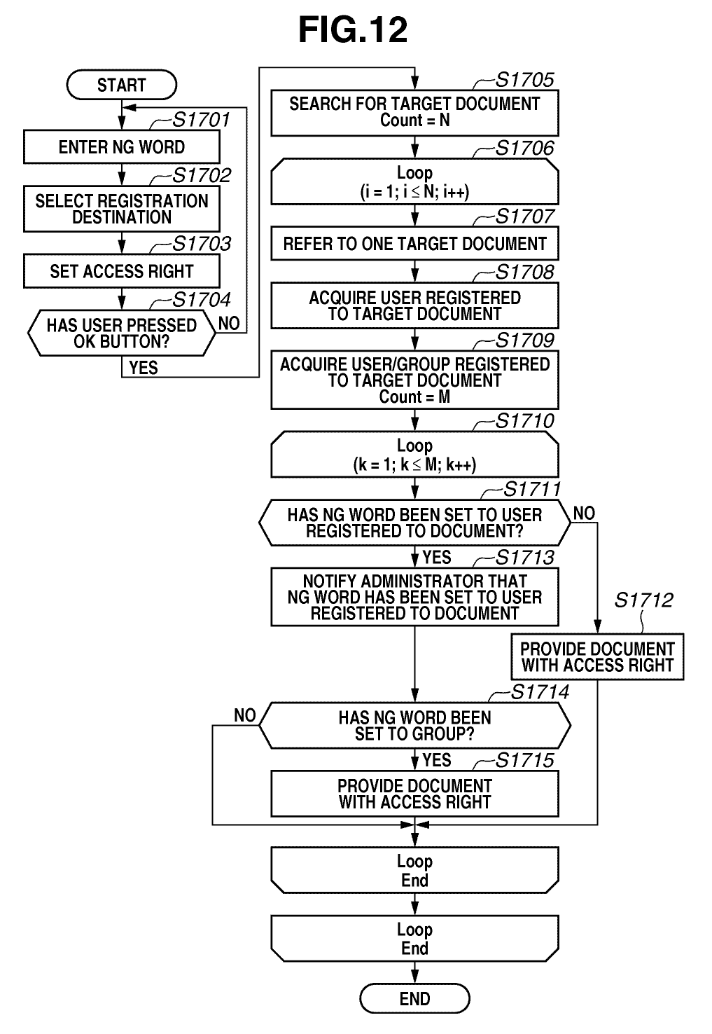

Now, a flow of processing for registering a character string of an NG word executed by the document management unit 306 will be described in detail below with reference to FIG. 12. FIG. 12 is a flow chart illustrating an example of NG word registration processing according to the present exemplary embodiment.

When the user presses the new NG word registration button 1603 via the NG word registration initial screen 1601 of an operation unit 202 (FIG. 2) and enters an NG word into the NG word entering text box 1609 via the document registration destination registration screen 1608, the processing in the flow chart in FIG. 12 starts. Referring to FIG. 12, in step S1701, the system control unit 201 receives the user input.

Then, the user selects an NG word registration destination via the NG word registration destination selection area 1611 and presses the new NG word registration destination registration button 1615. In step S1702, the system control unit 201 receives the user input.

Then, the user selects a user or a group via the user/group display area 1630 of the access right setting screen 1619 and presses the add button 1626. In step S1703, the system control unit 201 receives the user input and the user or the group is added to the user/group access right information display area 1622.

In step S1704, the document management unit 306 determines whether the user has pressed the OK button 1631. If it is determined that the user has pressed the OK button 1631 (YES in step S1704), then the system control unit 201 instructs the document management unit 306 to start the NG word registration processing and the processing advances to step S1705. On the other hand, if it is not determined so (NO in step S1704), then the processing returns to step S1701 and waits until an NG word is input. In step S1705, the document management unit 306 searches documents registered in the NG word registration destination for a document including the NG word by a full-text search.

In step S1706, if no document including the NG word has been found as a result of the search in step S1705, then the processing ends. On the other hand, if any document including the NG word has been found, then the document management unit 306 repeats the following processing in the following steps S1707 through S1715 for a number of times equivalent to a number of documents including the NG word extracted in step S1705.

In step S1707, the document management unit 306 acquires one document including the NG word extracted in step S1705. In step S1708, the document management unit 306 refers to attribute information of the document to acquire a user registered to the document (document-registered user). In step S1709, the document management unit 306 acquires a user or a group registered to the NG word.

In step S1710, the document management unit 306 repeats the following processing in steps S1711 through S1715 for a number of times equivalent to a number of the registered users or groups. In step S1711, the document management unit 306 determines whether the NG word has been set to the document-registered user. If it is determined that the NG word has been set to the document-registered user (YES in step S1711), then the processing advances to step S1713. On the other hand, if it is not determined so (NO in step S1711), then the processing advances to step S1712.

In step S1712, the document management unit 306 sets the access right associated with the NG word as the access right to the document. In this regard, if the user has been set to the NG word, the document management unit 306 sets the access right to the NG word to the user. On the other hand, if the group has been set to the NG word, the document management unit 306 sets the access right to the NG word to the group. In step S1713, the document management unit 306 notifies the user who has the administrator authority that the NG word has been set to the document-registered user by an e-mail or the like.

In step S1714, the document management unit 306 determines whether the group has the access right to the NG word. If it is determined that the group has the access right to the NG word (YES in step S1714), then the processing advances to step S1715. In step S1715, the document management unit 306 acquires the user included in the group and sets the access right that inhibits the users other than the document-registered user from reading and writing/modifying the document.

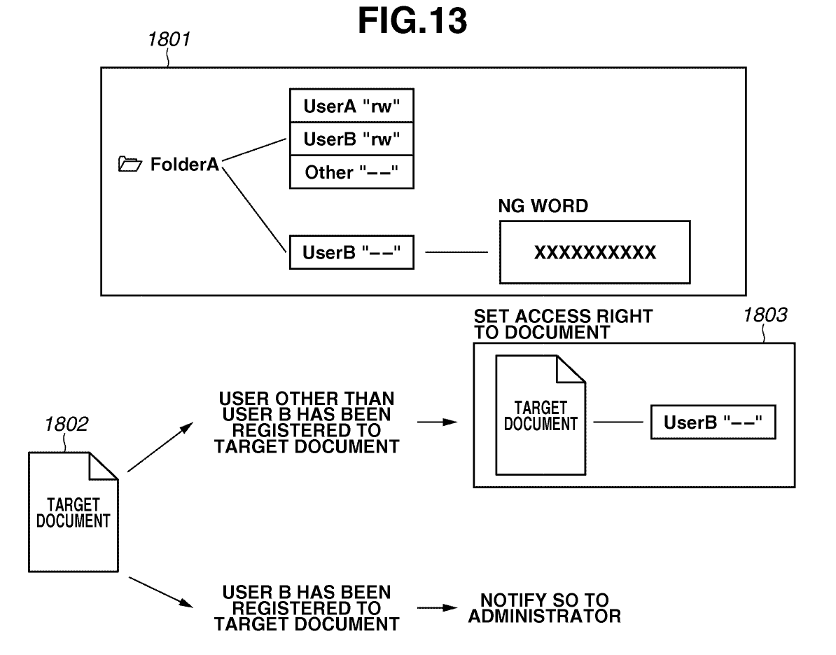

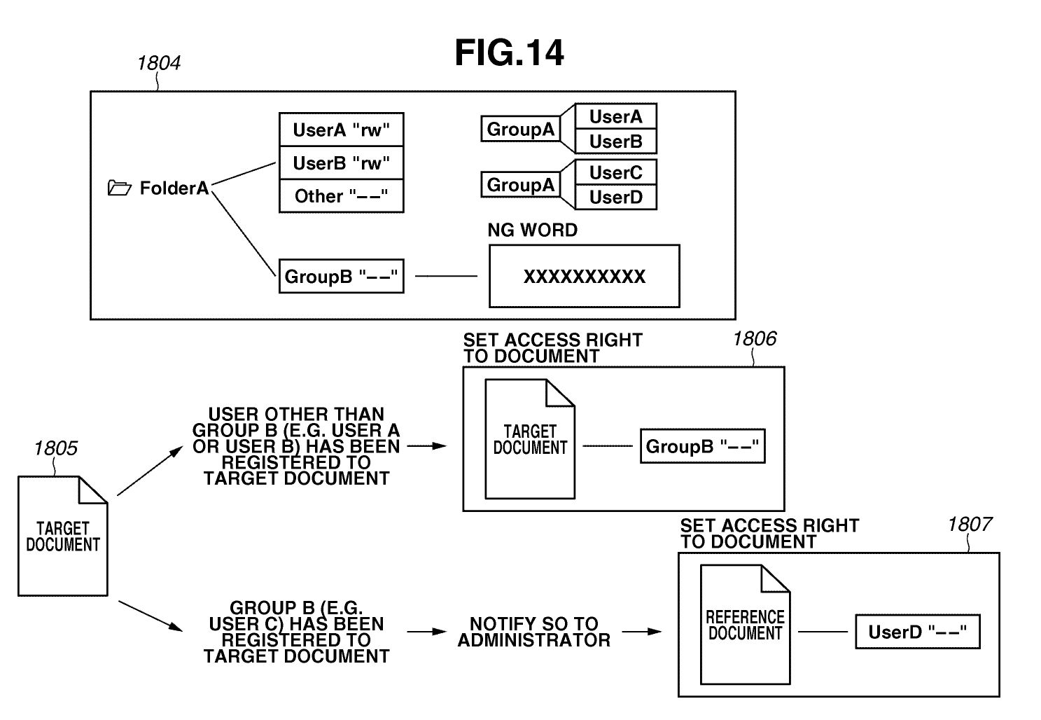

FIGS. 13 and 14 each illustrates an example of an operation executed during the NG word registration processing according to the present exemplary embodiment.

In a status 1801 in FIG. 13 and a status 1804 in FIG. 14, the access right and the NG word have been set to a folder “Folder A”. The status 1801 indicates that the reading right and the writing/modification right to the Folder A have been set to a user “User A” and a user “User B”. In addition, the status 1801 indicates that the access right that inhibits reading and writing/modifying the Folder A has been set to the other users “Other”.

Further, the status 1801 indicates that the NG word “XXXXXXXXX” has been registered in step S1701 (FIG. 12) as a status of setting the NG word and the Folder A has been set as the registration destination of the NG word “XXXXXXXXX” in step S1702 (FIG. 12). In addition, the status 1801 indicates that the access right that inhibits writing/modification of the Folder A has been set to the User B in step S1703 (FIG. 12).

If the registered user of a target document (a document including the NG word) 1802 (FIG. 13) acquired in step S1707 from among those extracted in step S1705 is a user other than the User B, then the following processing is executed. More specifically, the document management unit 306 sets the access right that inhibits reading and writing/modifying the target document to the User B as illustrated with a status 1803 (FIG. 13). If the registered user of the target document is the User B, the document management unit 306 notifies so to the administrator.

Referring to FIG. 14, the status 1804 indicates that the reading right and the writing/modification right to the Folder A have been set to a group “Group A” and a group “Group B”. In addition, the status 1804 indicates that the access right that inhibits reading and writing/modifying the Folder A has been set to the other users “Other”. Further, the status 1804 indicates that the User A and the User B belong to the Group A and that users “User C” and “User D” belong to the Group B.

In addition, the status 1804 indicates that the NG word “XXXXXXXXX” has been registered in step S1701 as the status of setting the NG word and the Folder A has been set as the registration destination of the NG word “XXXXXXXXX” in step S1702. In addition, the status 1804 indicates that the access right that inhibits writing/modification of the Folder A has been set to the Group B in step S1703.

If the registered user of a target document 1805 (FIG. 14) acquired in step S1707 from among those extracted in step S1705 is a user other than the Group B (the User A in this case), then the following processing is executed. More specifically, the document management unit 306 sets the access right that inhibits reading and writing/modifying the target document to the Group B as illustrated with a status 1806 (FIG. 14). If the registered user of the target document is the user included in the Group B (the User C in this case), the document management unit 306 notifies so to the administrator. In addition, the document management unit 306 sets the access right that inhibits reading and writing/modifying the target document to the user other than the User C of the Group B as illustrated with a status 1807 (FIG. 14).

When the NG word is changed, a registered NG word selection step is added and executed before entering an NG word in step S1701 (FIG. 12). Further, the NG word to be substituted with the new NG word is cleared before acquiring the target document in step S1705 (FIG. 12).

In the above-described manner, the present exemplary embodiment resets the access right to an existing document when a character string of an NG word is registered.

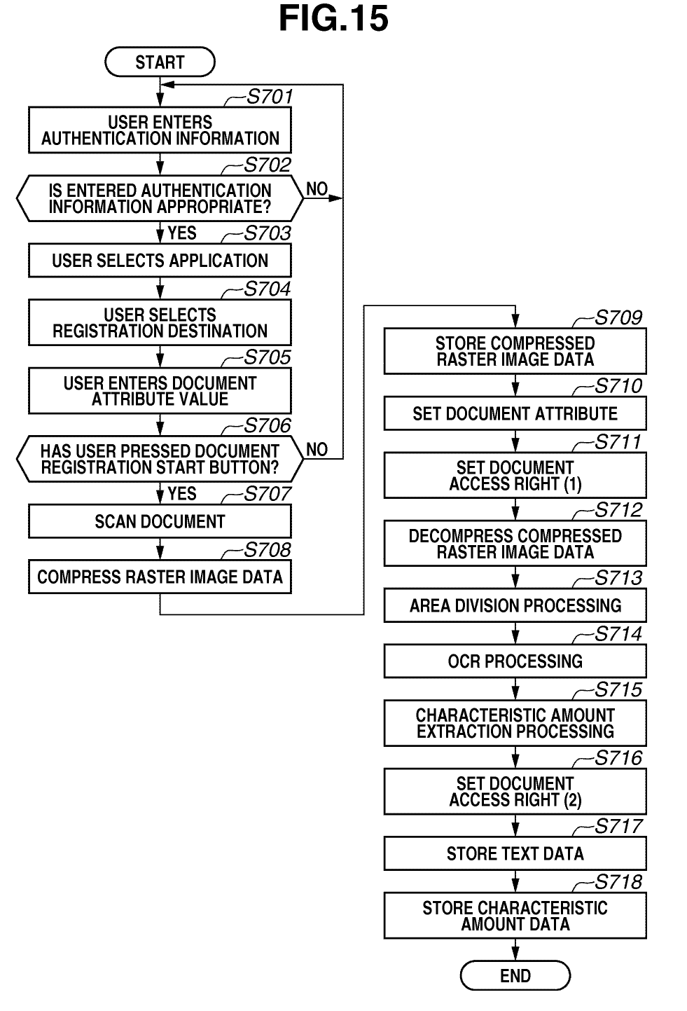

Now, document registration processing executed by the system control unit 201 will be described in detail below with reference to FIG. 15. FIG. 15 is a flow chart illustrating an example of document registration processing according to the present exemplary embodiment.

Referring to FIG. 15, in step S701, the user enters authentication information via the operation unit 202. A type of the authentication information required to enter in step S701 may differ according to an authentication method that the authentication server uses. Accordingly, in step S701, the system control unit 201 requests an authentication method to the authentication server 105 via the authentication unit 206 to display an authentication information input screen and acquires the authentication method. Here, Windows® NT LAN Manager (NTLM) authentication or Kerberos Certification can be used as the authentication method. The system control unit 201 displays the authentication information input screen according to the acquired authentication method on the operation unit 202.

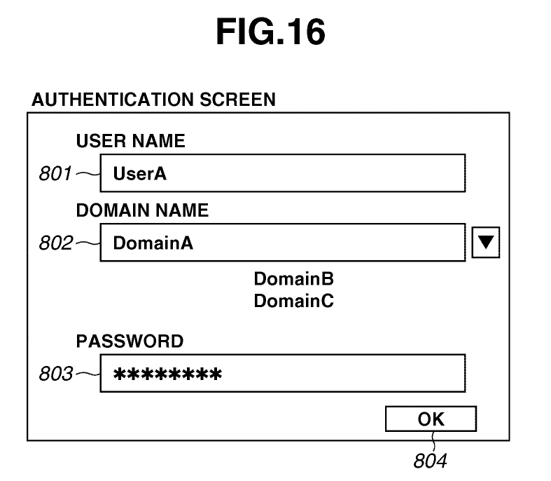

FIG. 16 illustrates an example of a user authentication information input screen via which the user enters a user name, a domain name, and a password required during the user authentication according to the present exemplary embodiment. Referring to FIG. 16, a user name entering text box 801 is a text box area for entering the user name. When the user selects the user name entering text box 801, a software keyboard is displayed on the operation unit 202. Thus, the user can easily input a text object.

A domain name entering text box 802 for entering the domain name includes a pull-down menu including a list of available domains. The user can select a desired domain from the domain list. A number of domains displayed in the list is equivalent to a number of authentication servers that the image forming apparatus 103 can be connected with. More specifically, the image forming apparatus 103 can be connected with a plurality of authentication servers. The authentication unit 206 may store user management information and execute the user authentication without communicating with the authentication server.

A password entering text box 803 is a text box area for entering the password. When the user enters the user name, the domain name, and the password and presses an OK button 804, the system control unit 201 transmits the entered authentication information to the authentication server 105 via the authentication unit 206.

When the user is successfully authenticated, the authentication server 105 issues a security token. The authentication unit 206 generates a user ID according to the security token. The document management unit 306 manages the access right of the user according to the user ID. The security token and the user ID correspond to each other one to one. With this configuration, the present exemplary embodiment can implement a uniform operation of communication with an external apparatus including the user authentication.

In step S702, the system control unit 201 determines whether the entered authentication information is appropriate. If the entered authentication information is determined appropriate (YES in step S702), then the processing advances to step S703. On the other hand, if the entered authentication information is determined not appropriate (NO in step S702), then the processing returns to step S701. In step S703, when the user selects an application via the operation unit 202, the system control unit 201 activates the selected application according to the authority of the user authenticated in step S701.

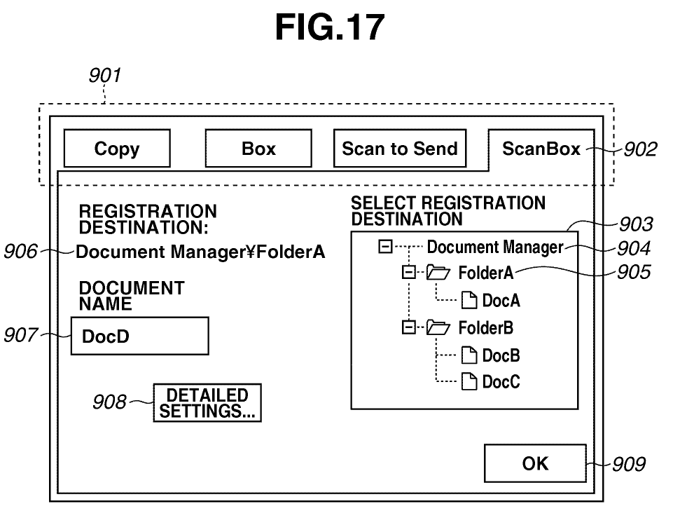

FIG. 17 illustrates a screen displayed by an application for registering a document according to the present exemplary embodiment. Referring to FIG. 17, an application selection area 901 includes four applications. In the example illustrated in FIG. 17, the user has selected a “Scan Box” application 902. A document management display area 903 displays a document and a folder managed by the document management unit 306. The document management display area 903 is similar to the document management area 1401 (FIG. 7).

Returning to FIG. 15, in step S704, when the user designates the registration destination of the document, the system control unit 201 receives the designated registration destination. In the example illustrated in FIG. 17, a Document Manager 904 is a repository and each of a Folder A 905 and a Folder B 905 is a folder. When the user designates a repository or a folder via the document management display area 903, the system control unit 201 sets the designated repository or folder as the registration destination. Further, a registration destination display area 906 displays a path to the registration destination upon the user designation via the document management display area 903.

In step S705, when the user enters attribution information of the document, the system control unit 201 receives the entered attribution information. The attribution information of a document includes a document name or the like.

A document name entering text box 907 (FIG. 17) is a text box area for entering the document name of the document data to be registered. When the user presses a details setting button 908, the screen shifts to a screen for entering the other document attributes (not illustrated). The user can enter the other document attributes in a corresponding entering text box via the corresponding document attribute input screen. It is always necessary for the user to enter the document name to register a document.

In step S706, the system control unit 201 determines whether the user has pressed a document registration start button (OK button 909 (FIG. 17)). The OK button 909 can be operated to start the document registration processing. The OK button 909 is displayed in a gray-out state and does not become operable until the user designates the registration destination and enters the document name.

When the user presses the OK button 909, the system control unit 201 advances to step S707. On the other hand, if the user cancels the operation, then the processing returns to step S701.

In step S707, the scanner unit 213 scans the image of a paper document 214 and generates raster image data based on the scanned document image according to an instruction from the system control unit 201. More specifically, the scanner unit 213 detects whether the paper document 214 exists with a built-in sensor (not illustrated). If no paper document 214 exists, the scanner unit 213 notifies “no document” error information to the system control unit 201. In this case, the system control unit 201 displays an error dialog on the screen of the operation unit 202. On the other hand, if the paper document 214 exists, the scanner unit 213 scans the image of the paper document 214 and generates the raster image data of the scanned document.

In step S708, the compression/decompression unit 208 compresses the raster image data according to an instruction from the system control unit 201. In step S709, the system control unit 201 instructs the document management unit 306 to store the compressed raster image data. The document management unit 306 stores the compressed image data in the repository or the folder designated in step S704.

In step S710, the document management unit 306 sets the document attribute. In step S711, the document management unit 306 executes document access right setting processing (1). In step S711, if an NG word has been registered, then the document management unit 306 sets the access right corresponding to the NG word to the document regardless of the content of the document to be registered.

The image processing in steps S712 through S715 consumes a large amount of the system resource. The priority of the image processing in steps S712 through S715 is lower than that of other processings. Accordingly, the image processing in steps S712 through S715 may be suspended if any higher priority processing, such as copy processing or print processing, is input during the image processing. Further, the registered document cannot be viewed by other users until the image processing in steps S712 through S715 is completed. The present exemplary embodiment sets the access right in step S711 to prevent the above-described problem.

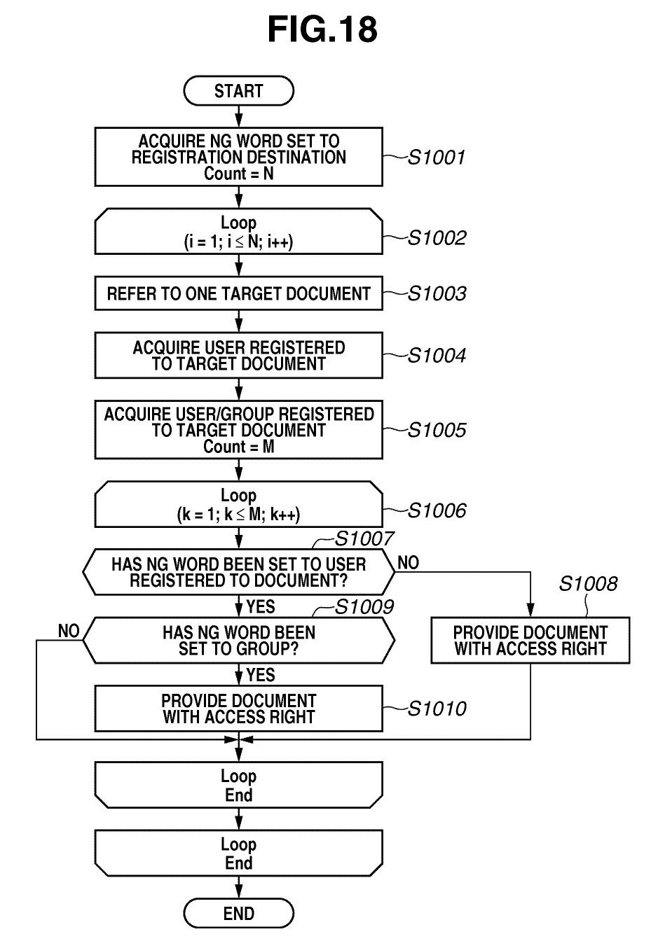

FIG. 18 is a flow chart illustrating a detail of the document access right setting processing (1) (processing in step S711 in FIG. 15) according to the present exemplary embodiment. Referring to FIG. 18, in step S1001, the document management unit 306 acquires an NG word set to the registration destination to which the document is to be registered.

In step S1002, if no NG word has been registered to the document registration destination, then the processing ends. On the other hand, if the NG word has been registered to the document registration destination, then the document management unit 306 repeats the following processing in step S1003 through S1010 for a number of times equivalent to a number of the registered NG words.

In step S1003, the document management unit 306 extracts one NG word from those acquired in step S1001. In step S1004, the document management unit 306 acquires the user registered to the document according to the attribute information of the document. In step S1005, the document management unit 306 acquires the user or group registered to the acquired NG word.

In step S1006, the document management unit 306 repeats the processing in steps S1007 through S1010 for a number of times equivalent to a number of the registered users or groups.

In step S1007, the document management unit 306 determines whether the access right to the NG word has been set to the document-registered user. If it is determined that the access right to the NG word has been set to the document-registered user (YES in step S1007), then the processing advances to step S1009. On the other hand, if it is not determined so (NO in step S1007), then the processing advances to step S1008.

In step S1008, the document management unit 306 sets the access right associated with the NG word as the access right to the document. In this regard, if the user has been set to the NG word, the document management unit 306 sets the access right to the NG word to the user. On the other hand, if the group has been set to the NG word, then the document management unit 306 sets the access right to the NG word to the group.

In step S1009, the document management unit 306 determines whether the group has the access right to the NG word. If it is determined that the group has the access right to the NG word (YES in step S1009), then the processing advances to step S1010. In step S1010, the document management unit 306 acquires the user included in the group and sets the access right that inhibits users other than the document-registered user from reading and writing/modifying the document.

Returning to FIG. 15, in step S712, the compressed raster image data is decompressed. More specifically, the system control unit 201 acquires the stored image data from the document management unit 306 and instructs the compression/decompression unit 208 to decompress the image data. The compression/decompression unit 208 decompresses the compressed image data according to the instruction from the system control unit 201.

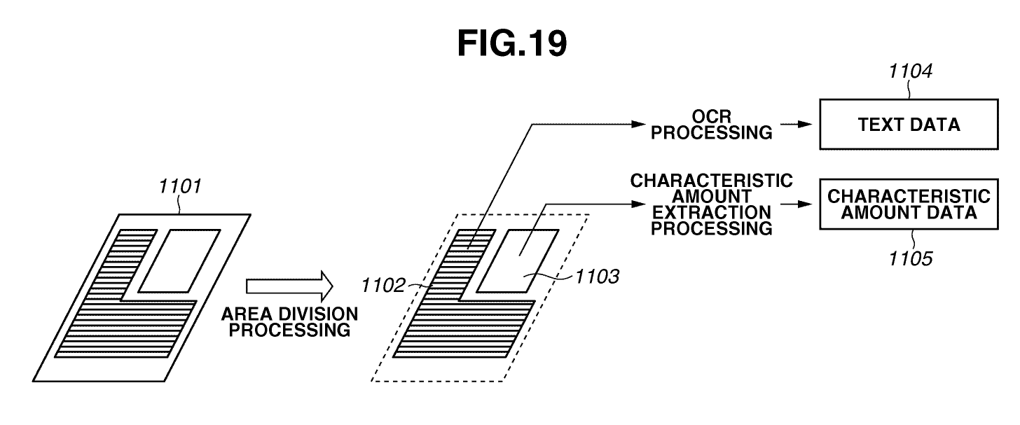

Area division processing in step S713, OCR processing in step S714, and characteristic amount extraction processing In step S715 will be described in detail below with reference to FIG. 19. Referring to FIG. 19, raster image data 1101 is an example of the raster image data decompressed in step S712 (FIG. 15). In step S713 (FIG. 15), the area division unit 603 of the image processing unit 204 executes area division processing on the raster image data 1101. The raster image data 1101 is divided into a character area 1102 and an image area 1103.

In step S714, the OCR unit 604 executes OCR processing on the area-divided character area 1102 and extracts text data 1104. In step S715, the image characteristic extraction unit 605 executes characteristic amount extraction processing on the area-divided image area 1103 and extracts characteristic amount data 1105.

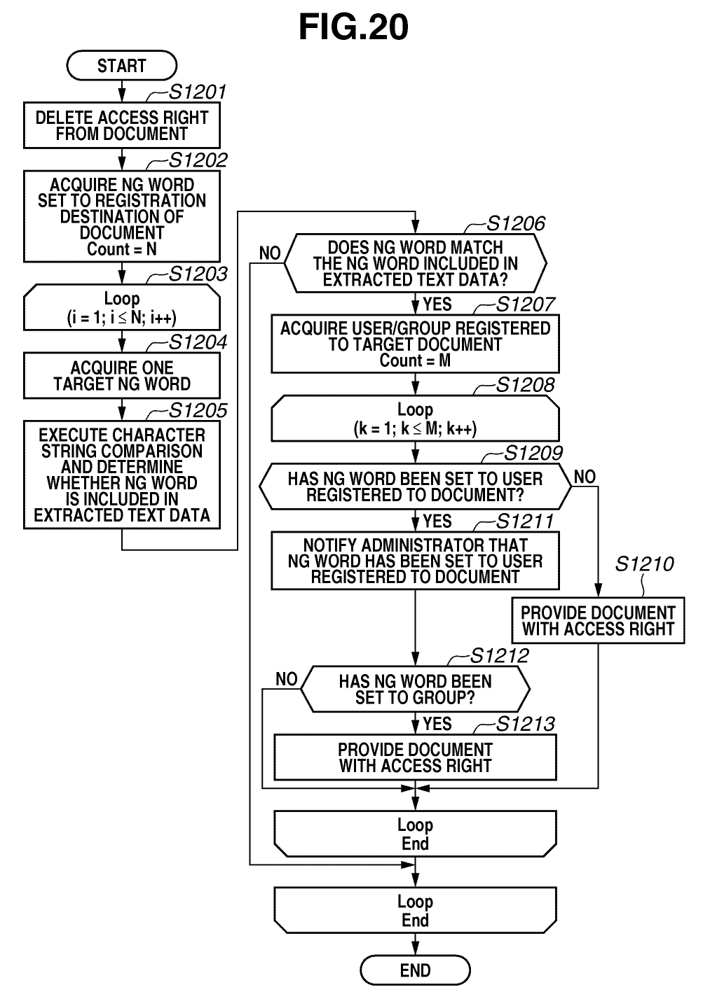

In step S716, the document management unit 306 executes document access right setting processing (2). The processing in step S716 will be described in detail below with reference to a flow chart in FIG. 20. FIG. 20 is a flow chart illustrating a detailed example of processing in step S716 according to the present exemplary embodiment.

Referring to FIG. 20, in step S1201, the document management unit 306 deletes the access right to the document set in step S711. In step S1202, the document management unit 306 acquires the NG word set to the document registration destination to which the document is to be registered.

In step S1203, if no NG word has been registered to the document registration destination, then the processing ends. On the other hand, if the NG word has been registered, then the document management unit 306 repeats the following processing in steps S1204 through S1213 for the number of times equivalent to the number of the registered NG words.

In step S1204, the document management unit 306 extracts one NG word from those acquired in step S1202. In step S1205, the document management unit 306 compares the NG word acquired in step S1204 with those included in the text data extracted in step S713. In step S1206, the document management unit 306 determines whether the NG words match one another. If it is determined that the NG words match one another (YES in step S1206), then the processing advances to step S1207. If the NG words do not match one another (NO in step S1206), then the processing ends the loop of processing and returns to step S1203.

In step S1207, the document management unit 306 acquires the user or group registered to the extracted NG word. In step S1208, the document management unit 306 repeats the processing in steps S1209 through S1213 for the number of times equivalent to the number of the registered users or groups.

In step S1209, the document management unit 306 determines whether the NG word has been set to the document-registered user. If it is determined that the NG word has been set to the document-registered user (YES in step S1209), then the processing advances to step S1211. On the other hand, if it is not determined so (NO in step S1209), then the processing advances to step S1210.

In step S1210, the document management unit 306 sets the access right associated with the NG word as the access right to the document. In this case, if the user has been set to the NG word, then the document management unit 306 sets the access right to the NG word to the user. On the other hand, if the group has been set to the NG word, then the document management unit 306 sets the access right to the NG word to the group. In step S1211, the document management unit 306 notifies the user who has the administrator authority that the NG word has been set to the document-registered user via an e-mail or the like.

In step S1212, the document management unit 306 determines whether the group has the access right to the NG word. If it is determined that the group has the access right to the NG word (YES in step S1212), then the processing advances to step S1213. In step S1213, the document management unit 306 acquires the user included in the group and sets the access right that inhibits the user other than the document-registered user from reading and writing/modifying the document.

Returning to FIG. 15, in step S717, the document management unit 306 registers the extracted text data 1104 as the document attribute. In step S718, the document management unit 306 registers the extracted characteristic amount data 1105 as the document attribute.

With the above-described configuration, the present exemplary embodiment previously registers an NG word to each user to the document registration destination such as a folder (first character string registration processing and second character string registration processing). Further, when the document is registered, the present exemplary embodiment compares the NG word with the content of the document extracted by the OCR processing and sets the access right to the document to the user.

When a document including the registered NG word is stored in the folder to which the NG word has been registered, the present exemplary embodiment automatically sets an access right to the stored document (first setting processing and second setting processing).

With the above-described configuration, the present exemplary embodiment can appropriately set an access right to each user according to the content of a document. Accordingly, the present exemplary embodiment can prevent the leakage of confidential information included in a document. In addition, the present exemplary embodiment can simplify an operation for setting an access right.

In a second exemplary embodiment, an NG image which is generated based on an image characteristic amount is used instead of the above-described NG word which is a character string. In the present exemplary embodiment, the configuration different from that of the first exemplary embodiment will be described.

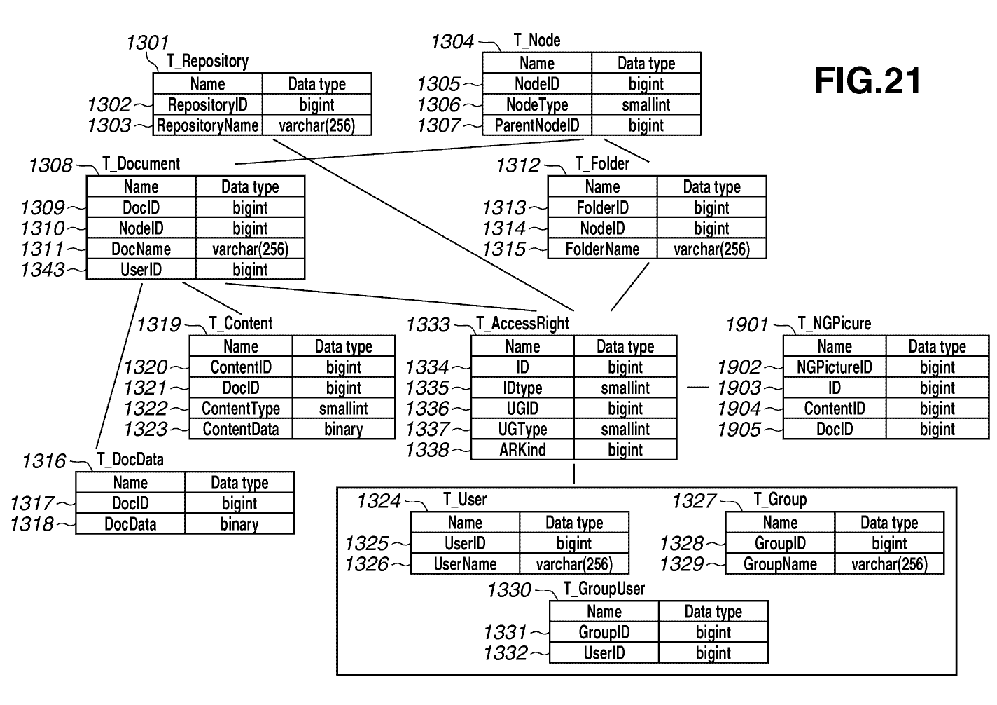

FIG. 21 illustrates an example of a structure of tables stored in the document management unit 306 according to the present exemplary embodiment. In the present exemplary embodiment, the units and components similar to those in the first exemplary embodiment are provided with the same reference numerals and symbols. Accordingly, the detailed description thereof will not be repeated here.

Referring to FIG. 21, a T_NGPicture table 1901 manages data of an NG image. The T_NGPicture table 1901 includes an NG Picture ID item 1902, an ID item 1903, a content ID item 1904, and a Doc ID item 1905. The NG Picture ID item 1902 stores numeric data for uniquely identifying the NG image. The ID item 1903 stores numeric data. A value of the ID item 1903 is stored in the ID item 1334 of the T_AccessRight table 1333 (FIG. 5). The value of the ID item 1903 associates the NG image with the access right information.

A value of the content ID item 1904 is stored in the content ID item 1320 of the T_Content table 1319 (FIG. 5) and associates the content with the NG image. A value of the Doc ID item 1905 is stored in the Doc ID item 1309 of the T_Document table 1308 and associates the NG image with document data.

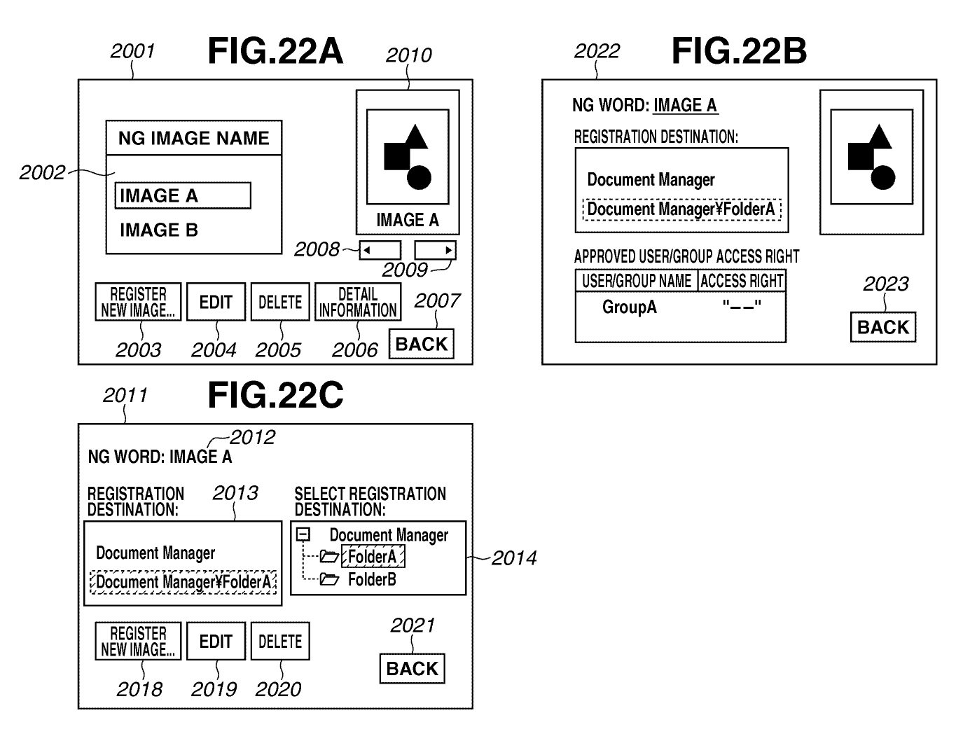

FIGS. 22A, 22B, and 22C each illustrates a display screen for registering the NG image according to the present exemplary embodiment. Referring to FIG. 22A, an NG image registration initial screen 2001 is an initial screen for registering an NG image. A registered NG image name display area 2002 displays a name of a registered NG image. The user can designate an NG image name from those displayed in the registered NG image name display area 2002.

A new NG image registration button 2003 can be operated to register a new NG image. When the user presses the new NG image registration button 2003, the screen shifts to a document registration destination registration screen 2011. An NG image editing button 2004 can be operated to change the setting that has been set to an already registered NG image. When the user designates an NG image name that has been already registered via the registered NG image name display area 2002 and presses the NG image editing button 2004, the screen shifts to the document registration destination registration screen 2011.

A registered NG image deleting button 2005 can be operated to delete a registered NG image. When the user designates an NG image name via the registered NG image name display area 2002 and presses the registered NG image deleting button 2005, the designated registered NG image is deleted. A details button 2006 can be operated to display detailed information about the setting of the registered NG image. When the user designates an NG image name via the registered NG image name display area 2002 and presses the details button 2006, the screen shifts to an NG image detailed information display screen 2022 illustrated in FIG. 22B. A back button 2007 can be operated to return to a screen that has been displayed previous to the NG image registration initial screen 2001.

When the user presses a selection button 2008 or 2009, an NG image display area 2010 displays an image registered in the document management unit 306. The administrator authority is necessary to newly register, edit, or delete an NG image. Accordingly, a button for shifting to the NG image registration initial screen 2001 is not displayed unless the user has the administrator authority. Although not illustrated in FIGS. 22A through 22C, the administrator authority can be set to a registered user. If the administrator authority is set to the user, the user is provided with an authority to execute all operations.

Referring to FIG. 22C, the document registration destination registration screen 2011 is a screen for setting an NG image registration destination. An NG image name display area 2012 displays a registered NG image name. An NG image registration destination display area 2013 displays an already registered registration destination of a registered NG image. An NG image registration destination selection area 2014 is a display area for selecting an NG image registration destination.

A new NG image registration destination registration button 2018 can be operated to register a new registration destination of the NG image. When the user selects the NG image registration destination selection area 2014, the new NG image registration destination registration button 2018 becomes operable. When the user presses the new NG image registration destination registration button 2018, the screen shifts to the access right setting screen 1619 (FIG. 11B).

An NG image registration destination editing button 2019 can be operated to change the registration destination of the NG image. When the user designates the already registered registration destination via the NG image registration destination selection area 2014, the NG image registration destination editing button 2019 becomes operable. When the user presses the NG image registration destination editing button 2019, the screen shifts to the access right setting screen 1619 (FIG. 11B).

A registration destination deleting button 2020 can be operated to delete a registered registration destination.

When the user designates a registration destination via the NG image registration destination display area 2013 and presses the registration destination deleting button 2020, the designated registration destination is deleted. A back button 2021 can be operated to return to the NG image registration initial screen 2001.

The NG image detailed information display screen 2022 (FIG. 22B) displays detailed information about a registered NG image. When the user presses the back button 2023, the screen returns to the NG image registration initial screen 2001.

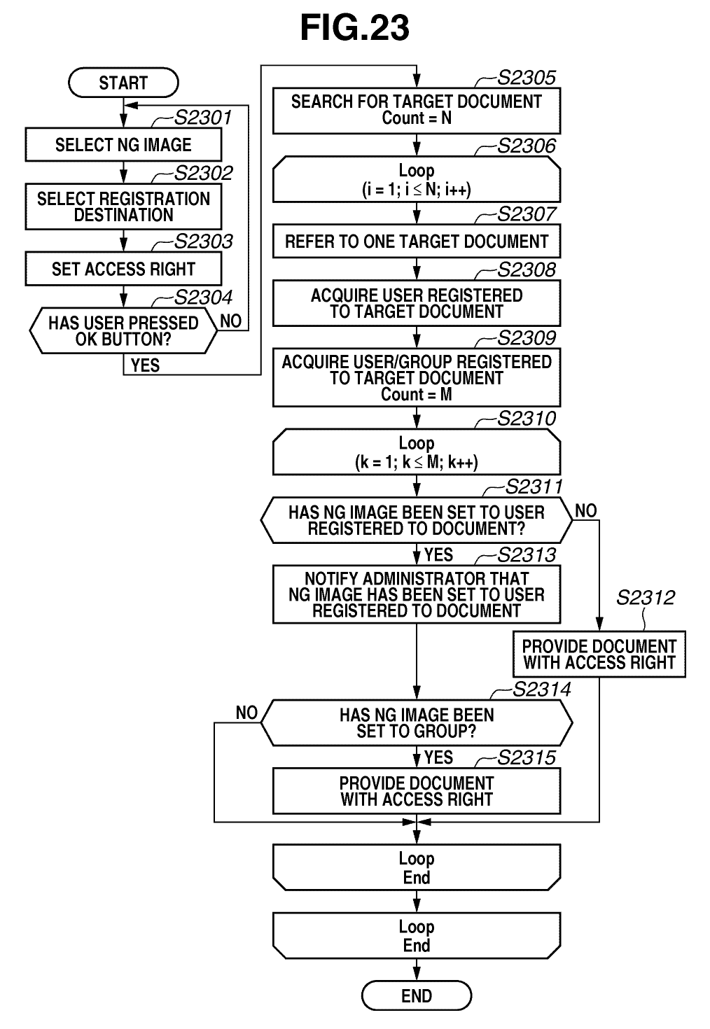

NG image characteristic amount registration processing executed by the document management unit 306 will be described in detail below with reference to FIG. 23. FIG. 23 is a flow chart illustrating an example of processing for registering an NG image according to the present exemplary embodiment.

Referring to FIG. 23, in step S2301, when the user designates an NG image via the NG image registration initial screen 2001 of the operation unit 202 and presses the new NG image registration button 2003, the system control unit 201 receives the designated NG image. In step S2302, when the user selects an NG image registration destination via the NG image registration destination selection area 2014 and presses the new NG image registration destination registration button 2018, the system control unit 201 receives the designated NG image registration destination.

In step S2303, when the user designates a user or a group from the user/group display area 1630 via the access right setting screen 1619, the system control unit 201 receives the designated user or group. Then, the system control unit 201 adds the designated user or group to the user/group access right information display area 1622.

In step S2304, when the user presses the OK button 1631, the system control unit 201 receives the user instruction and instructs the document management unit 306 to start NG image registration processing.

In step S2305, the document management unit 306 searches documents registered in the NG image registration destination for an image similar to the NG image by a similar image search. More specifically, the document management unit 306 extracts a document having an image similarity degree higher than a predetermined value in the similar image search.

In step S2306, if no document has been extracted in step S2305, then the processing ends. On the other hand, if a document including an image whose similarity degree is higher than the predetermined value, the document management unit 306 repeats the processing in steps S2307 through S2309 for a number of times equivalent to a number of such documents.

In step S2307, the document management unit 306 extracts one document from those extracted in step S2305. In step S2308, the document management unit 306 acquires the document-registered user from the attribute information of the document. In step S2309, the document management unit 306 acquires the user or the group registered to the NG image.

In step S2310, the document management unit 306 repeats the processing in step S2311 through S2315 for the number of times equivalent to the number of registered users or groups. In step S2311, the document management unit 306 determines whether the NG image has been set to the document-registered user. If it is determined that the NG image has been set to the document-registered user (YES in step S2311), then the processing advances to step S2313. On the other hand, if it is not determined so (NO in step S2311), then the processing advances to step S2312.

In step S2312, the document management unit 306 sets the access right associated with the NG image as the access right to the document. In this case, if the user has been set to the NG image, then the document management unit 306 sets the access right to the NG image to the user. On the other hand, if the group has been set to the NG image, then the document management unit 306 sets the access right to the NG image to the group. In step S2313, the document management unit 306 notifies the user who has the administrator authority that the NG image has been set to the document-registered user via an e-mail or the like.

In step S2314, the document management unit 306 determines whether the group has the access right to the NG image. If it is determined that the group has the access right to the NG image (YES in step S2314), then the processing advances to step S2315.

In step S2315, the document management unit 306 acquires the user included in the group and sets the access right that inhibits the user other than the document-registered user from reading and writing/modifying the document.

The document registration processing according to the second exemplary embodiment is similar to that described above with reference to FIG. 15 in the first exemplary embodiment except the content of the processing in steps S711 and S716. Accordingly, the processing in steps S711 and S716 only will be described in detail below.

In step S711, the document management unit 306 executes the document access right setting processing (1). More specifically, in step S711, if an NG image has been registered, the document management unit 306 sets the access right associated with the NG image to the document regardless of the content of the document to be registered.

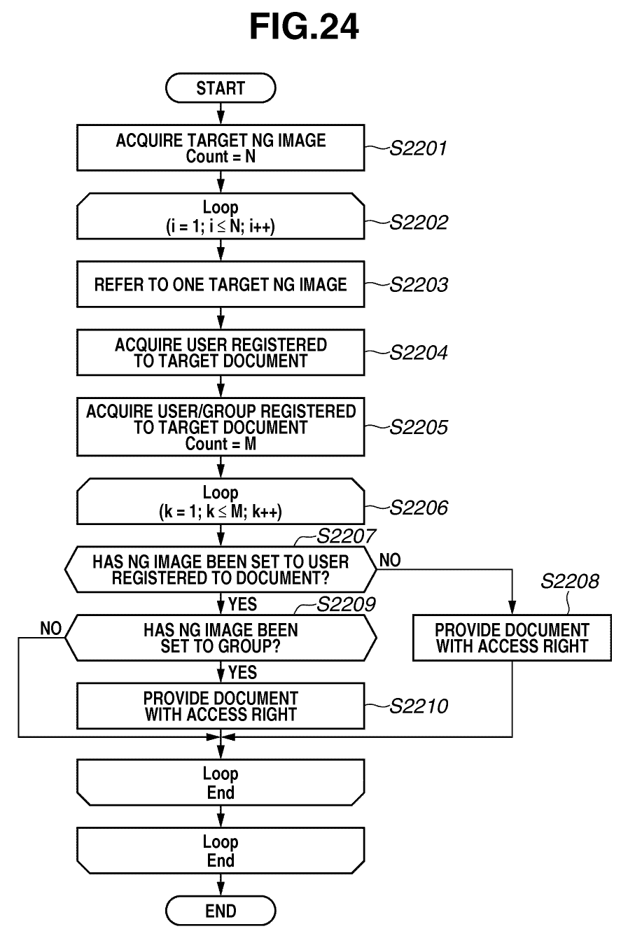

The processing in step S711 according to the present exemplary embodiment will be described in detail below with reference to FIG. 24. FIG. 24 is a flow chart illustrating an example of the document access right setting processing (1) (step S711 in FIG. 15) according to the present exemplary embodiment.

Referring to FIG. 24, in step S2201, the document management unit 306 acquires the NG image set to the registration destination to which the document is to be registered. In step S2202, if no NG image has been registered to the document registration destination, then the processing ends. On the other hand, if the NG image has been registered to the document registration destination, then the document management unit 306 repeats the processing in step S2203 through S2210 for the number of times equivalent to the number of the registered NG images.

In step S2203, the document management unit 306 extracts one NG image from those acquired in step S2201. In step S2204, the document management unit 306 acquires the document-registered user from the attribute information of the document. In step S2205, the document management unit 306 acquires the user or group registered to the extracted NG image.

In step S2206, the document management unit 306 repeats the processing in step S2207 through S2210 for the number of times equivalent to the number of the registered users or groups. In step S2207, the document management unit 306 determines whether the document-registered user has the access right to the NG image. If it is determined that the document-registered user has the access right to the NG image (YES in step S2207), then the processing advances to step S2209. On the other hand, if it is not determined so (NO in step S2207), then the processing advances to step S2208.

In step S2208, the document management unit 306 sets the access right associated with the NG image as the access right to the document. In this case, if the user has been set to the NG image, then the document management unit 306 sets the access right to the NG image to the user. On the other hand, if the group has been set to the NG image, then the document management unit 306 sets the access right to the NG image to the group.

In step S2209, the document management unit 306 determines whether the group has the access right to the NG image. If it is determined that the group has the access right to the NG image (YES in step S2209), then the processing advances to step S2210.

In step S2210, the document management unit 306 acquires the user included in the group and sets the access right that inhibits users other than the document-registered user from reading and writing/modifying the document.

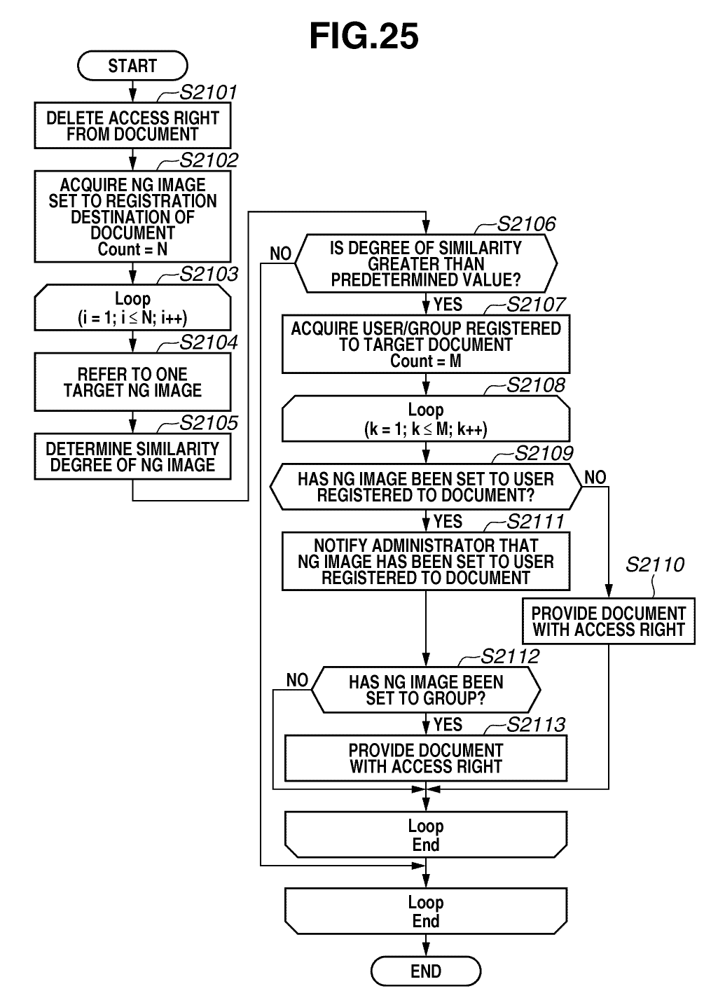

The processing in step S716 (FIG. 15) according to the present exemplary embodiment will be described in detail below Referring to FIG. 25. FIG. 25 is a flow chart illustrating an example of the document access right setting processing (2) according to the present exemplary embodiment.

Referring to FIG. 25, in step S2101, the document management unit 306 deletes the access right to the document set in step S711. In step S2102, the document management unit 306 acquires the NG image set to the document registration destination to which the document is to be registered. In step S2103, if the NG image has not been registered to the document registration destination, then the processing ends. On the other hand, if the NG image has been registered to the document registration destination, then the document management unit 306 repeats the processing in steps S2104 through S2113 for the number of times equivalent to the number of the registered NG images.

In step S2104, the document management unit 306 extracts one NG image from those acquired in step S2102. In step S2105, the document management unit 306 determines a degree of similarity between image characteristic amount data of the NG image extracted in step S2104 and the image characteristic amount data extracted in step S715.

In step S2106, the document management unit 306 determines whether the similarity degree between the image characteristic amount data is equal to or higher than a predetermined value. If the similarity degree between the image characteristic amount data is equal to or higher than a predetermined value (YES in step S2106), then the processing advances to step S2107. On the other hand, if the similarity degree between the image characteristic amount data is lower than the predetermined value (NO in step S2106), then the processing ends the loop of processing and returns to step S2103.

In step S2107, the document management unit 306 acquires the user or group registered to the extracted NG image. In step S2108, the document management unit 306 repeats the processing in step S2109 through S2113 for the number of times equivalent to the number of the registered users or groups.

In step S2109, the document management unit 306 determines whether the NG image has been set to the document-registered user. If it is determined that the NG image has been set to the document-registered user (YES in step S2109), then the processing advances to step S2111. On the other hand, if it is not determined so (NO in step S2109), then the processing advances to step S2110.

In step S2110, the document management unit 306 sets the access right associated with the NG image as the access right to the document. In this case, if the user has been set to the NG image, the document management unit 306 sets the access right to the NG image to the user. On the other hand, if the group has been set to the NG image, the document management unit 306 sets the access right to the NG image to the group. In step S2111, the document management unit 306 notifies the user who has the administrator authority that the NG image has been set to the document-registered user via an e-mail or the like.

In step S2112, the document management unit 306 determines whether the group has the access right to the NG image. If the group has the access right to the NG image (YES in step S2112), then the processing advances to step S2113. In step S2113, the document management unit 306 acquires the user included in the group and sets the access right that inhibits users other than the document-registered user from reading and writing/modifying the document.

The present invention can also be achieved by providing a system or an apparatus with a storage medium storing program code of software implementing the functions of the above described embodiments and by reading and executing the program code stored in the storage medium with a computer of the system or the apparatus (a CPU or a micro processing unit (MPU)).

In this case, the program code itself which is read from the storage medium implements the functions of the embodiments described above, and accordingly, the storage medium storing the program code constitutes the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-131975 filed May 20, 2008, which is hereby incorporated by reference herein in its entirety.

What is claimed is:

1. An information processing apparatus comprising:
a document registration unit configured to register a document;
a data extraction unit configured to extract a content of the document;
a first setting unit configured to set an access right to the document to each user; and
a first character string registration unit configured to register a character string for each user,
wherein the first setting unit, when the document is registered by the document registration unit, sets an access right of a user to the document based on a result of comparison of the character string registered by the first character string registration unit with the content of the document extracted by the data extraction unit.

2. The information processing apparatus according to claim 1, further comprising a notification unit, when a user corresponding to the character string registered by the first character string registration unit registers a document including the character string by using the document registration unit, configured to notify an administrator that the document is registered.

3. The information processing apparatus according to claim 1, further comprising a resetting unit, when a character string is registered by the first character string registration unit, configured to reset an access right to an existing document.

4. The information processing apparatus according to claim 1, further comprising:
a second setting unit configured to set an access right to a document registration destination to each user; and
a determination unit configured, when a document is registered by the document registration unit, to determine whether a character string has been registered in association with a user who has an access right to the document registration destination, wherein
the access right of the user to the document is set, if it is determined by the determination unit that the character string has been registered, based on a result of comparison of the registered character string with the content of the document extracted by the data extraction unit.

5. The information processing apparatus according to claim 1, further comprising:
a third setting unit configured to set an access right to a document to each group; and
a second character string registration unit configured to register a character string for each group, wherein
when a document is registered by the document registration unit, an access right to the document is set to a group based on a result of comparison of the character string registered by the second character string registration unit with the content of the document extracted by the data extraction unit.

6. The information processing apparatus according to claim 1, further comprising a temporary access right setting unit configured to set a temporary access right of a user that temporarily allows the user to access the document when a document is registered by the document registration unit, wherein when the content of the document has been completely extracted by the data extraction unit, the first setting unit sets an access right of the user to the document based on a result of comparison of the character string registered by the first character string registration unit with the content of the document extracted by the data extraction unit.

7. An information processing apparatus comprising:
a document registration unit configured to register a document;
a data extraction unit configured to extract a content of the document;
a setting unit configured to set an access right to the document to each user; and
an image characteristic amount registration unit configured to register an image characteristic amount for each user, wherein
the setting unit, when the document is registered by the document registration unit, sets an access right of a user to the document based on a result of comparison of the image characteristic amount registered by the image characteristic amount registration unit with the content of the document extracted by the data extraction unit.

8. A method for controlling an information processing apparatus, the method comprising:
registering a document;
extracting a content of the document;
registering a character string for each user; and
when the document is registered, setting an access right of a user to the document based on a result of comparison of the registered character string with the extracted content of the document.

9. A method for controlling an information processing apparatus, the method comprising:
registering a document;
extracting a content of the document;
registering an image characteristic amount for each user; and
when the document is registered, setting an access right of a user to the document based on a result of comparison of the registered image characteristic amount and the extracted content of the document.
